(19) United States
(12) Patent Application Publication
(10) Pub. No.: US 2022/0012252 A1
(43) Pub. Date: Jan. 13, 2022

(54) AUTOMATED DATASET CALCULATION USING GEOSPATIAL RELATIONSHIPS

(71) Applicant: Mapline Inc., Pleasant Grove, UT (US)

(72) Inventors: Brady V. Anderson, Pleasant Grove, UT (US); Rahul Saurav, Pleasant Grove, UT (US); Jared H. Gunther, Pleasant Grove, UT (US)

(21) Appl. No.: 16/926,574

(22) Filed: Jul. 10, 2020

(51) Int. Cl. G06F 16/2457; G06F 16/29; G06F 16/23

(52) U.S. Cl. CPC G06F 16/24575; G06F 16/24573; G06F 16/2358; G06F 16/29

(57) ABSTRACT

Collecting data and augmenting a dataset based on geospatial relationships. A primary dataset is obtained. At a user interface, a list of dataset types for collecting data are provided. A secondary dataset is obtained based on a received dataset type selection. For each record of the primary dataset, a reduced secondary dataset is determined based on filter parameters selected at the user interface. Filter parameters include at least a geospatial relationship based on geospatial data from the primary and secondary datasets. For each record of the primary dataset, a corresponding value is derived from records of the reduced secondary dataset based on identified geospatial relationships to the corresponding record from the primary dataset. An augmented primary dataset is generated comprising data from the primary dataset and an additional data field comprising, for each record of the primary dataset, the respective corresponding value.

### BACKGROUND OF THE INVENTION

Over the years, access to various types of spatial data continues to increase. Additionally, there has been a continued growth in applications of datasets with spatial data among various industries and applications. In data analysis, the augmenting datasets with additional information allows for the generation of additional insights that would not be possible with the original separate datasets. Spatial data (e.g. geospatial data) can be used to relate records from one dataset to another. Existing methods of collecting and combining data from multiple datasets call for knowledge of unique syntax and complicated formulas. Current solutions call for a substantial analysis of the underlying data prior to the formulation of a usable data collection algorithm. Calculating useful parameters or generating results using current methods calls for a prior assessment of e.g. viable ranges and compatible formats. Even in the case that the underlying data is properly assessed and a formula has been constructed, the augmentation of a dataset with additional data using existing tools can still require advanced knowledge component functions, their syntax, required and/or optional parameters, and limitations. In general, augmenting datasets with additional data from other sources is a labor intensive and complicated process subject to user errors.

### SUMMARY OF THE INVENTION

Described herein are systems and methods for collecting data and augmenting a dataset based on geospatial relationships with other datasets or other data elements. In an embodiment, a primary dataset comprising at least one record is obtained. At a user interface, a list of dataset types for collecting data are provided. A secondary dataset is obtained based on a received dataset type selection. For each record of the at least one record of the primary dataset, a reduced secondary dataset is determined based on filter parameters selected at the user interface. The filter parameters include at least a geospatial relationship based on geospatial data from the primary dataset and geospatial data from the secondary dataset. For each record of the at least one record of the primary dataset, a corresponding value is derived from one or more records of the reduced secondary dataset, the one or more records of the reduced secondary dataset having an identified geospatial relationship to the corresponding record from the primary dataset. An augmented primary dataset is generated, the augmented primary dataset comprising data from the primary dataset and an additional data field comprising, for each record of at the least one record of the primary dataset, the respective corresponding value.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic illustration of a data flow for a data collection process in accordance with some embodiments

FIG. 2 is a schematic illustration of a network topology and application stack comprising multiple services and engines, in accordance with some embodiments.

FIG. 3 is an example method for data collection in accordance with some embodiments.

FIG. 4 is a first example screenshot of a user interface in a scenario for collecting demographic information based on a geospatial relation in accordance with some embodiments.

FIG. 5 is a second example screenshot of a user interface in a scenario for collecting demographic information based on a geospatial relation in accordance with some embodiments

FIG. 6 is a third example screenshot of a user interface in a scenario for collecting demographic information based on a geospatial relation in accordance with some embodiments

FIG. 7 is a fourth example screenshot of a user interface in a scenario for collecting demographic information based on a geospatial relation in accordance with some embodiments

FIG. 8 is a fifth example screenshot of a user interface in a scenario for collecting demographic information based on a geospatial relation in accordance with some embodiments

FIG. 9 is a sixth example screenshot of a user interface in a scenario for collecting demographic information based on a geospatial relation in accordance with some embodiments.

FIG. 10 is a seventh example screenshot of a user interface in a scenario for collecting demographic information based on a geospatial relation in accordance with some embodiments.

FIG. 11 is a first example screenshot of a user interface in a scenario for collecting data related to a set of territories in accordance with some embodiments.

FIG. 12 is a second example screenshot of a user interface in a scenario for collecting data related to a set of territories in accordance with some embodiments.

FIG. 13 is a third example screenshot of a user interface in a scenario for collecting data related to a set of territories in accordance with some embodiments.

FIG. 14 is a first example screenshot of a user interface in a scenario for collecting data relating to distances between records of a primary dataset and records of a secondary dataset in accordance with some embodiments

FIG. 15 is a second example screenshot of a user interface in a scenario for collecting data relating to distances between records of a primary dataset and records of a secondary dataset in accordance with some embodiments

FIG. 16 is a third example screenshot of a user interface in a scenario for collecting data relating to distances between records of a primary dataset and records of a secondary dataset in accordance with some embodiments

FIG. 17 is a first example screenshot of a user interface in a scenario for collecting data using a lookup of a value in accordance with some embodiments.

FIG. 18 is a second example screenshot of a user interface in a scenario for collecting data using a lookup of a value in accordance with some embodiments.

FIG. 19 is a first example screenshot of a user interface in a scenario for collecting data using a count in accordance with some embodiments.

FIG. 20 is a second example screenshot of a user interface in a scenario for collecting data using a count in accordance with some embodiments.

FIG. 21 is a first example screenshot of a user interface in a scenario for collecting data using a calculation on aggregate data from a secondary dataset based on geospatial relationships.

FIG. 22 is a second example screenshot of a user interface in a scenario for collecting data using a calculation on aggregate data from a secondary dataset based on geospatial relationships.

FIG. 23 is a third example screenshot of a user interface in a scenario for collecting data using a calculation on aggregate data from a secondary dataset based on geospatial relationships.

FIG. 24 is a first example screenshot of a user interface in a scenario for collecting data based on a determination that records of a primary and secondary dataset are inside the same territory.

FIG. 25 is a second example screenshot of a user interface in a scenario for collecting data based on a determination that records of a primary and secondary dataset are inside the same territory.

FIG. 26 is a flow diagram of a first example method for collecting data based on identified geospatial relationships in accordance with some embodiments.

FIG. 27 is a flow diagram of a second example method for collecting data based on identified geospatial relationships in accordance with some embodiments.

FIG. 28 is a block diagram depicting user data acquisition and preprocessing in accordance with some embodiments.

FIG. 29 is a block diagram depicting a data collection process in accordance with some embodiments.

FIG. 30 is a block diagram depicting a data collection process for a lookup calculation, in accordance with some embodiments.

FIG. 31 is a block diagram depicting a data collection process for an aggregation calculation, in accordance with some embodiments.

FIG. 32 shows an example screenshot of a spreadsheet-like interface, in accordance with some embodiments.

FIG. 33A depicts a straight-line distance geospatial relationship.

FIG. 33B depicts a shortest driving distance geospatial relationship.

FIG. 33C depicts a fastest driving time geospatial relationship.

FIG. 33D depicts a fastest driving time with traffic geospatial relationship.

FIG. 33E depicts a shared territory geospatial relationship.

FIG. 34 depicts a chart that utilizes an augmented dataset, in accordance with some embodiments.

FIG. 35 depicts a report that utilizes an augmented dataset, in accordance with some embodiments.

FIGS. 36A-36B depict a map interface that utilizes an augmented dataset, in accordance with some embodiments.

FIG. 37 depicts an interface element for customizing map labels, in accordance with some embodiments.

FIG. 38 depicts a map interface with pins and corresponding pop-out data views, in accordance with some embodiments.

FIG. 39 depicts a heat map that utilizes an augmented dataset, in accordance with some embodiments.

FIG. 40 depicts an interface element for customizing a heat map, in accordance with some embodiments.

FIG. 41 depicts a map interface with segmented data, in accordance with some embodiments.

FIG. 42 depicts an interface element for segmenting data, in accordance with some embodiments.

FIG. 43 depicts an interface element for selecting criteria for a data segment, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Described herein are systems and methods for collecting data and augmenting a dataset using geospatial relationships.

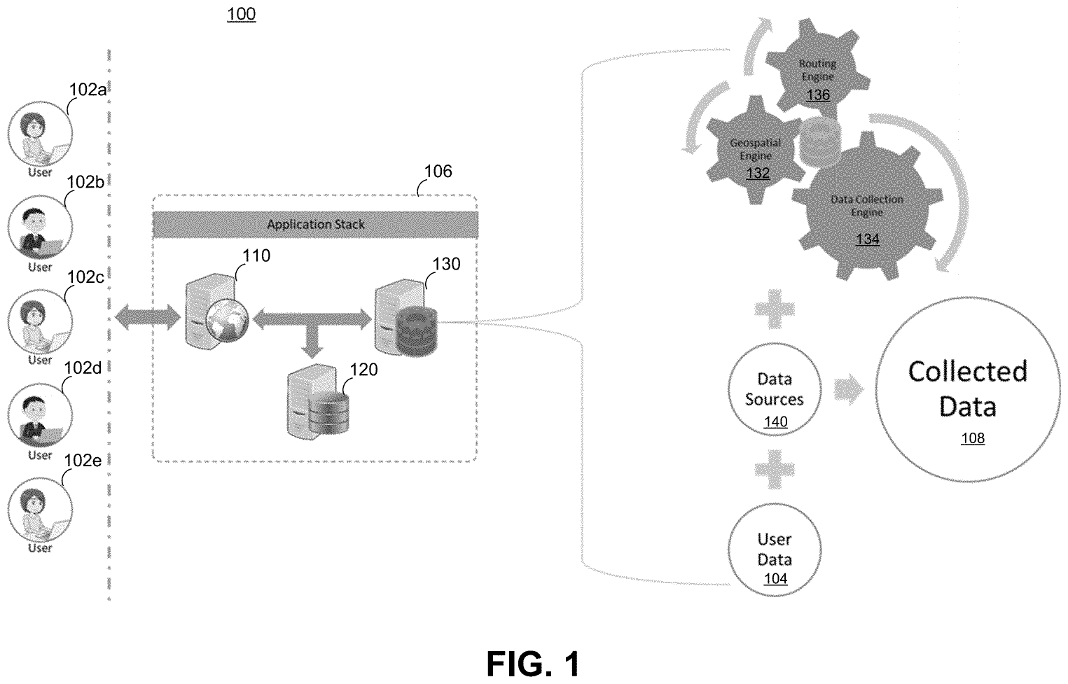

FIG. 1 is a schematic illustration of a data flow for a data collection process in accordance with some embodiments. In particular, FIG. 1 depicts users 102a-102e and application stack 106. Application stack 106 includes web service stack 110, data storage stack 120, and data collection service stack 130.

With respect to the data flow shown in FIG. 1, a user may submit a request to collect data via a graphical user interface (GUI) application or an application programming interface (API) application of application stack 106 using any data transfer protocol or framework available for networked devices.

Example GUIs employed in some embodiments include web applications and applications installed on user devices (e.g. computers, mobile devices, smart devices, and the like). A web application, for example, may be accessed via a web browser available on an operating system of a user device. In some embodiments, a GUI application is installed locally on an operating system of a user device. In some embodiments, a plug-in is installed and/or added to an application (e.g. Excel Add-in, Google Sheets Add-on, etc.).

An application programming interface (API) application is an application consisting of set of definitions and protocols that allow technology products and services to communicate with each other via the network (e.g., world wide web, internet, or private network). Example APIs include a system or software that uses an address, i.e., URL on the World Wide Web, internet or private network, to provide access to its services. Further examples of APIs include a system or software that uses a TCP/IP address on the internet or private network to provide access to its service.

The GUI and API applications may be employed as the front-end interface of application stack 106. The interfaces may use any or combination of various data transfer protocols and frameworks over networked devices to communicate with services on application stack 106. A sample list of protocols and frameworks currently being used are HTTP, HTTPS, TELNET, TCP\IP, UDP, REST, SOAP, RPC, XML-RPC, JSON-RPC. Application stack 106 may include various services and engines for performing different analyses to aid in the process of data collection. Application stack 106 may include various curated secondary dataset sources to enrich data, e.g. an initial dataset provided by or chosen by the user.

In accordance with some embodiments, a user (e.g. any of users 102a-e depicted in FIG. 1) submits a data collection request through application interface (e.g. a GUI or API provided by application stack 106). Upon receiving the user request, appropriate services and/or engines initiate various actions and operations on the user requests, as discussed in greater detail below. Operations and actions may include various analysis such as geospatial analysis, distance analysis, and routing analysis (e.g. performed by geospatial engine 132, data collection engine 134, and routing engine 136, respectively). Some embodiments enable the augmentation of user-provided with application-curated data from a list of curated secondary dataset sources based on the user request. In some embodiments, once the services and/or engines complete the process of collecting data, a service in the application stack 106 notifies the user of the status of the request(s). Using one or more of data from secondary dataset sources 140 and user data 104 in conjunction with the services and engines described above, collected data 108 is generated.

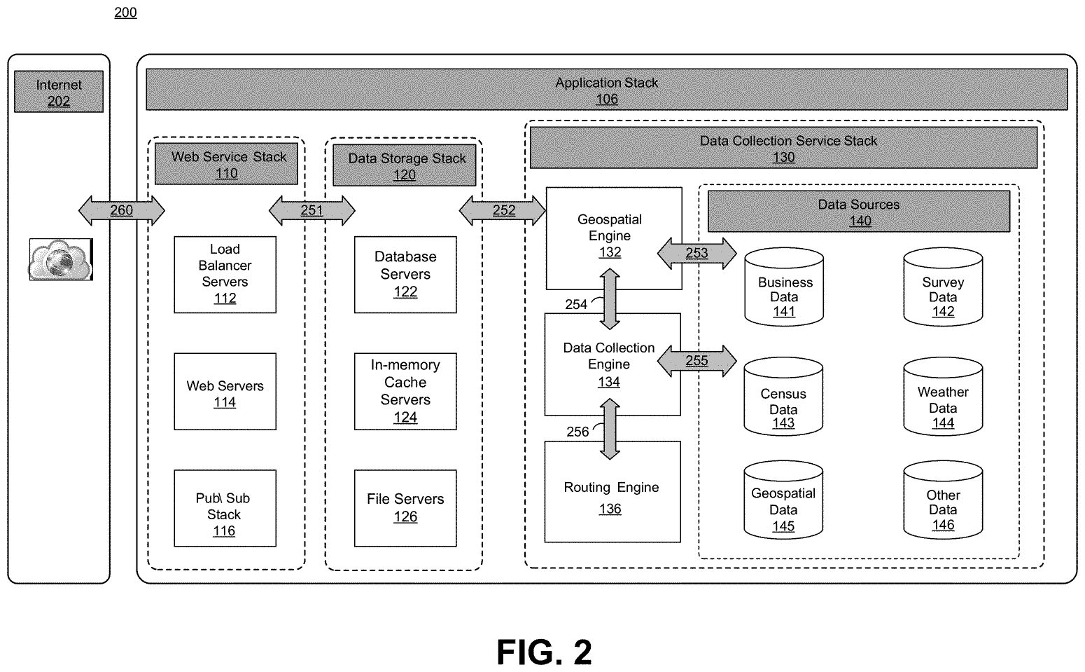

FIG. 2 is a schematic illustration of a network topology and application stack comprising multiple services and engines, in accordance with some embodiments. In particular, FIG. 2 depicts internet 202 and application stack 106. Application stack 106 includes web service stack 110, data storage stack 120, and data collection service stack 130.

Web service stack 110 includes load balancing servers or services 112, web servers 114, and publication/subscription (pub/sub) stack 116. Load balancers such as load balancing servers 112 help distribute the load to multiple web server. Web servers 114 host the GUI or API and serve them using any of various data transfer protocols and frameworks over networked devices or internet. Pub/sub stack 116 hosts the publisher/subscriber service, which handles messaging and notification events to GUI or API applications.

Data storage stack 120 comprises various data storage services. As depicted in FIG. 2, data storage stack 120 includes database servers or services 122, in-memory cache servers 124, and file servers 126. Database servers may include relational database management system (RDBMS) and NoSQL type databases and form the data storage backbones. User requests and data are stored in the database, in-memory cache, or in a file and are accessed by different services in the application stack. In-memory cache servers 124 may be used for caching data into memory. In-memory cache servers 124 can be useful for providing faster access to data over database storage.

Data collection service stack 130 may include multiple engines and secondary dataset sources which can be helpful for facilitating the data collection service based on user requests. As shown in FIG. 2, data collection service stack 130 includes geospatial engine 132, data collection engine 134, routing engine 136, and secondary dataset sources 140. Geospatial engine 132 may include one or more micro services to provide geospatial analysis and geospatial data.

Data collection engine 134 is a central processing unit for data collection requests and can analyze data collection requests submitted by a user through GUI or API and generate a set of workflow actions to collect data or update collected data. Data collection engine 134 may connect with other engines such as geospatial engine 132, routing engine 136, and secondary dataset sources 140, e.g. in order to fulfil user requests.

Routing engine 136 may include one or more services configured to provide routing information, route-based analysis, and route optimizations. In some embodiments, route-based analysis and optimizations include real-time traffic data. In some embodiments, routine engine 136 is configured to provide routing information and analysis based on historical traffic data and/or driving distance/time models.

Secondary dataset sources 140 may include various secondary dataset sources for supplementing data collection services. As shown in the figure, secondary dataset sources 140 includes business data 141, survey data 142, census data 143, weather data 144, geospatial data 145, and other data 146. The secondary dataset sources depicted in FIG. 2 are provided merely as examples for illustrative purposes and not by limitation. In some embodiments, secondary dataset sources are curated for the application, e.g. for an intended use. In some embodiments, secondary dataset sources may be imported by a user.

In accordance with the network topology depicted in FIG. 2, users may access a user interface (e.g. GUI or API) over networked devices and internet 202. The application stack 106 includes various service stacks that may be inter-connected via a network such as private network connections 251-255. Requests from users may be filtered through firewall 260. The various services of application stack 106 may use load balancing or scaling to meet demands of parallel user requests.

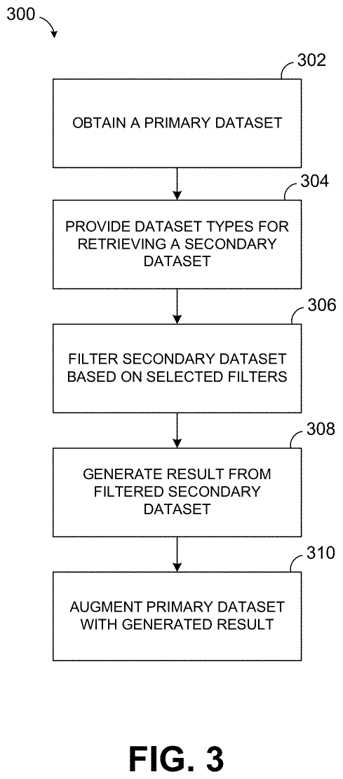

FIG. 3 is an example method for data collection in accordance with some embodiments. The method 300 includes, at 302, obtaining a primary dataset. At 304, the method includes providing dataset types for retrieving a secondary dataset. At 306, the method includes filtering the secondary dataset based on selected filter parameters. At 308, the method includes generating a result from the filtered secondary dataset. At 310, the method includes augmenting the primary dataset with the generated result.

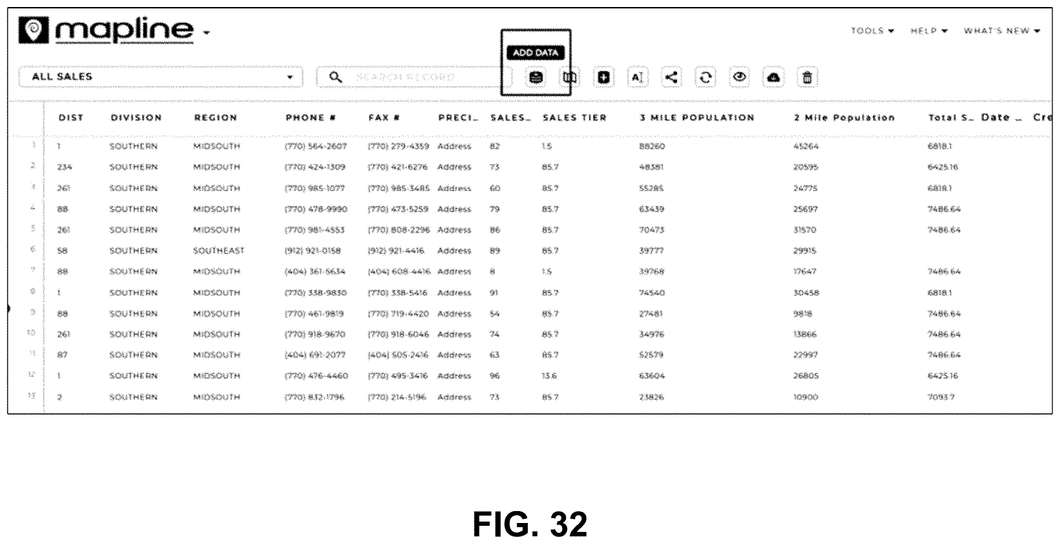

In some embodiments, obtaining a primary dataset 302 includes obtaining the primary dataset via one or more data entry fields at the user interface. For example, a primary dataset may be obtained as follows. A user can access a spreadsheet (e.g. a Microsoft Excel spreadsheet) or similar spreadsheet-like representation of data and copy any range of cells and paste data into the user interface. In some embodiments, data can be input by a user via a data entry form. In some embodiments, data is imported. Methods of importing data include uploading a spreadsheet, importing through applications and or plugins (e.g. Excel Add-in, Google Sheets Add-on, etc.), importing via a third-party platform, or upload via an automated feed via API. The entered and/or imported data may include a header row which has the name of each column. The system enables the user to save the information as a new dataset. Saved datasets may be maintained in a user's dataset library which may be stored e.g. at data storage stack 120. In some embodiments, the user can open saved or imported datasets via the system's user interface to see their data in a spreadsheet-like interface. FIG. 32 shows an example screenshot of a spreadsheet-like interface in accordance with some embodiments. After import, the user has access to a dataset which can be added to maps, used in charts or reports, or augmented with additional data via a data collection process. In some embodiments, a primary dataset is obtained by retrieving a dataset from local storage (e.g. local database, local cache, or local file) or via a network (e.g. from a database server, cache, or file server).

In some embodiments, a data collection process is initiated at the spreadsheet-like interface view of the dataset by selecting a button at the interface, such as the “Add Data” button depicted in FIG. 32. Methods for data collection enable the user to collect information from other sources (e.g. a secondary dataset) that is geospatially related to each row of data in their dataset. Referring to 304 of method 300, the method further includes providing dataset types for retrieving a secondary dataset. Various dataset types are presented to the user for selection. The user can choose a dataset type to retrieve desired information that can be geospatially tied to the records of their data. For example, a dataset type may be chosen by first selecting from a list of dataset sources displayed at a user interface. Then, categories of data associated with the selected dataset source may be provided at the interface, and the user may select a data category from the provided list. A secondary dataset can be retrieved using the user selections. Example secondary datasets that can be geospatially tied to the records of the primary dataset include demographic data, weather data, crime data, traffic data, territory data, company locations, points of interest, business data (e.g. datasets from a user's dataset library, datasets imported from spreadsheets, etc.), and other data. Demographic data may include, for example population, households, household size, and household income, and may be retrieved from various sources. In some embodiments, demographic data can be obtained from census data, e.g. population and households. Census data may also include other demographic data such as household income.

Datasets previously imported or saved by the user may be accessed and tied to the present dataset. In some embodiments, the secondary dataset is obtained by retrieving a dataset from local storage (e.g. local database, local cache, or local file) or via a network (e.g. from a database server, cache, or file server).

Referring now to step 306, the method 300 includes filtering the secondary dataset based on selected filter parameters. The user may be presented, via the user interface, various parameters for honing in on the information to be collected and returned. Filter logic may be applied in various ways Filter conditions applied to the records of the secondary dataset can be conditions defined in relation to the primary dataset, as discussed below. Additionally, filter conditions applied to the records of the secondary dataset can be conditions defined in relation to the secondary dataset itself.

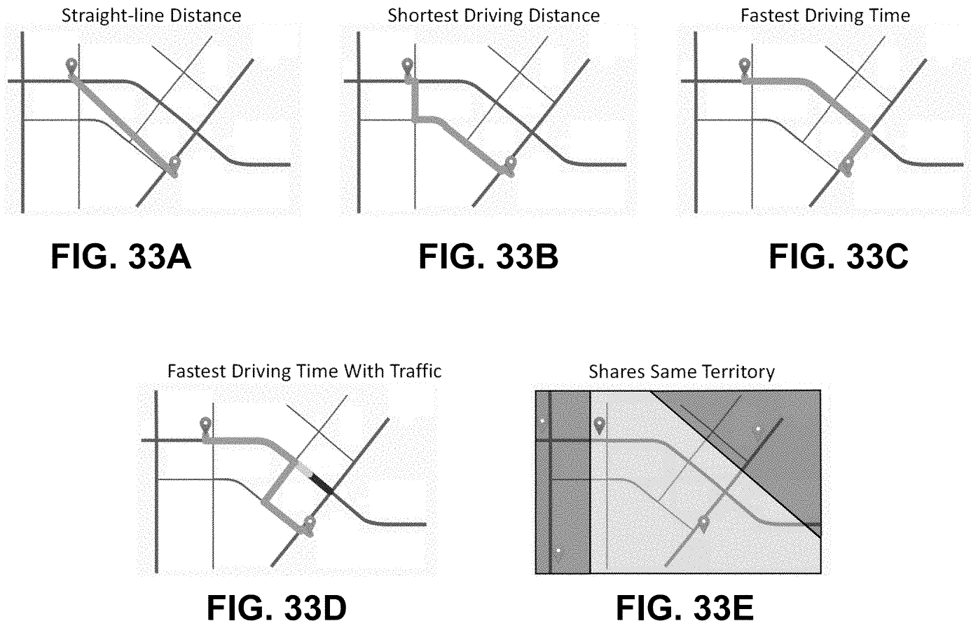

At step 306, relationship filter logic can be applied in order to filter records from the secondary dataset relative to values from the primary dataset. For example, geospatial filter logic can be applied to identify records from the secondary dataset that have a particular geospatial relationship to each record of the primary dataset. Example geospatial relationships include straight-line distance, a shared territory, a driving distance, and a driving time associated with a route (e.g. a fastest route or shortest distance route). FIGS. 33A-33E illustrate various geospatial relationships. Fastest and/or shortest route information may be determined via routing engine 136 as depicted in FIGS. 1 and 2. More generally, at relationship filter logic can be applied in order to identify and filter records from the secondary dataset that share a particular data relationship with the particular record of the primary dataset. For example, by setting a particular filter parameter, records of the secondary dataset may be filtered out if, for a given column, they do not share the same value as the particular record of the primary dataset. Alternatively, the filter parameters may include options for setting a range for a particular data column. In such embodiments, the records of the secondary dataset are filtered based on if the data column values are within a range of the associated value from the record of the primary dataset.

At 306, additional data filter parameters can be selected for filtering records of the secondary dataset based on information within that same dataset. In this way, records of the secondary dataset can be further refined or filtered, regardless of if they meet the relationship filter logic as described above. These, filter parameters may include, for example, at least one data filter parameter that identifies (i) a data field of the secondary dataset and (ii) a filter condition. A reduced secondary dataset may be determined based on filter parameters, e.g. by filtering out records of the secondary dataset that do not meet the filter condition for the identified data field.

Logical operators may be available for defining filter parameters. Example logical operators include but are not limited to: Equals/Does Not Equal, Greater Than/Less Than, Greater Than Or Equal To/Less Than Or Equal To, Is Between, Is Not Between, Contains, Does Not Contain, Begins With, Ends With, and the like. A particular filter parameter may be selected at the user interface by selecting logical operators and entering or selecting corresponding value(s).

At 308, the method 300 includes generating a result from the filtered secondary dataset. In some embodiments, generating the result from the filtered secondary dataset includes prompting the user to select what type of data to pull from the filtered secondary dataset.

In some embodiments, generating the result from the filtered secondary dataset at 308 includes performing a lookup on the corresponding filtered secondary dataset. In the case that a user selects the lookup option, the user may be prompted to select a data type to sort. Example data types to sort by include an existing column of the secondary dataset or a calculated column containing values pertaining to the geospatial relationship between the records of the reduced secondary dataset and the record of the primary dataset to which they are being compared. Said geospatial relationship values may be calculated by the geospatial engine 132. Example calculated geospatial relationships include straight-line distance, a driving distance, or a drive time based on a shortest or fastest route. The user additionally selects the data type to return. At the interface, the user may be prompted to select an index number to select the particular ranked record from which to return the desired value. As an illustrative example, a primary dataset pertaining to a set of retail stores can be augmented by collecting data on a secondary dataset pertaining to a list of gas stations. At 310, by performing a lookup process, the dataset pertaining to the list of retail stores can be augmented at by adding a column that contains the distance to the nearest gas station.

In some embodiments, generating the result from the filtered secondary dataset at 308 includes counting the number of records in the corresponding filtered secondary dataset. At 310, the primary dataset can be augmented with the generated result by adding to each record of the primary dataset the count of records of the filtered secondary dataset. Using the illustrative example above with respect to a primary dataset pertaining to a list of retail stores and a secondary dataset pertaining to a list of gas stations, a count process can be used to augment the dataset pertaining to a list of stores by adding a column that contains the number of gas stations within a 5-mile radius of each store. Notably, this scenario employs geospatial relationship filter logic based on a straight-line distance, wherein the records are filtered at 306 by using filter parameters comprising a “less than” operator and a value of 5 miles.

In some embodiments, generating result from filtered secondary dataset at 308 includes performing a calculation on the resulting records in the corresponding filtered secondary dataset. In such embodiments, the user may be prompted to enter, select, or otherwise define a calculation to be performed on the filtered records. With regard to the filtered records, the user may select a particular dataset column or a particular geospatial relationship with which to perform a calculation. An example non-inclusive list of calculations includes calculating a sum, average, standard deviation, median, etc. Using the illustrative example above with respect to a primary dataset pertaining to a list of retail stores and a secondary dataset pertaining to a list of gas stations, a calculation process for generating a result from the filtered secondary dataset can include selecting a dataset column of “gas price” and a calculation chose of “average.” In this example, the calculation can be used to generate, for each record of the primary dataset, the average gas price of the filtered records (e.g. all gas stations within a 5-mile radius).

In some embodiments, augmenting a primary dataset with a generated result comprises adding a new field (e.g. a column of dataset values) comprising the generated result values for each record of the primary dataset. In some embodiments, the augmented primary dataset is automatically updated in response to a modification to at least one of the primary dataset and the secondary dataset. For example, the new field may be dynamic field so that if any data changes (from the primary and/or secondary datasets), then new field values are automatically updated according to the data collection logic described above. Moreover, data collection processes for adding new columns can be repeated, whereby further additional fields are added and automatically updated in response to modifications to the relevant data. In some embodiments, the new field is static and does not automatically update in response to changes to data from either or both of the primary or secondary datasets. It should be noted that the terms “field” and “data field” herein refer generally to the way in which data is present and accessible in a spreadsheet-like data column or in any alternative data structure formats including XML, CSV, JSON, etc., and do not imply a particular kind of storage limited to the context of a database.

In some embodiments, the augmented primary dataset can be displayed in a filterable view. In such embodiments, some or all of the data of the primary dataset is displayed at the user interface. In some such embodiments, commands to filter the augmented primary dataset are received at the user interface, and a filtered view of the augmented primary dataset is displayed. Indeed, additional filtering, analysis, and visualization tools can be provided at the user interface and used for interacting with datasets and generated augmented datasets.

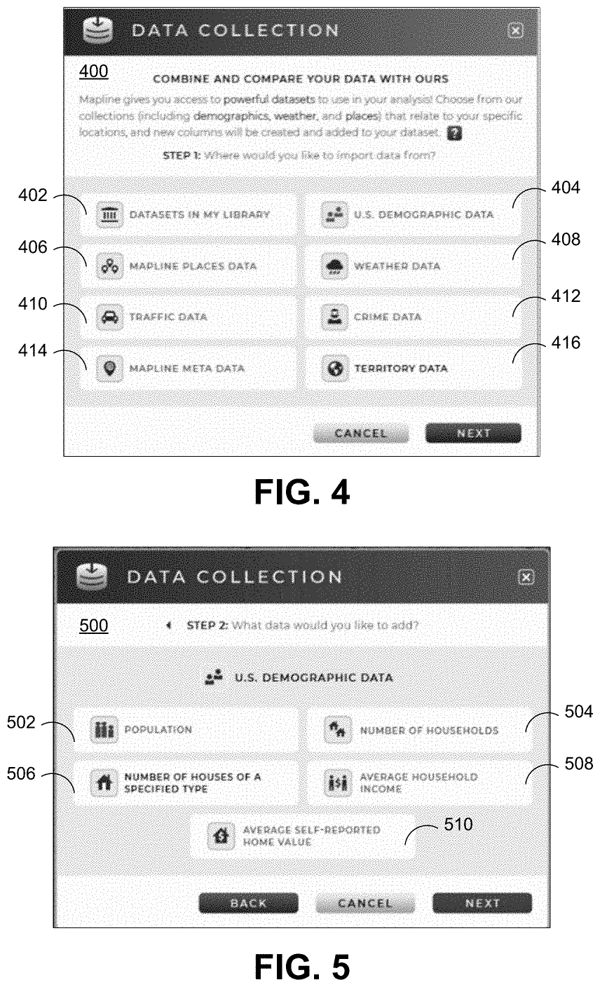

FIGS. 4-25 provide example screenshots that could be presented as or via the client-side user interface of the present systems and methods. In at least one embodiment, these screenshots are presented via a web browser or application GUI that is being executed by a user device.

FIG. 4 shows an example first screen that a user may be presented with by initiating a data collection request at the user interface, e.g. by selecting an “add data” button at a current spreadsheet-like view of a primary dataset as previously described. The screenshot 400 depicts a first step for collecting data from a secondary dataset onto the primary dataset. At this screen, the user is guided through a process to select a data type associated with secondary dataset sources from which to import data. In some embodiments, a list of data sources is provided. Once a particular data source is selected, the user may be further prompted to select from a list of data categories relevant to the selected source.

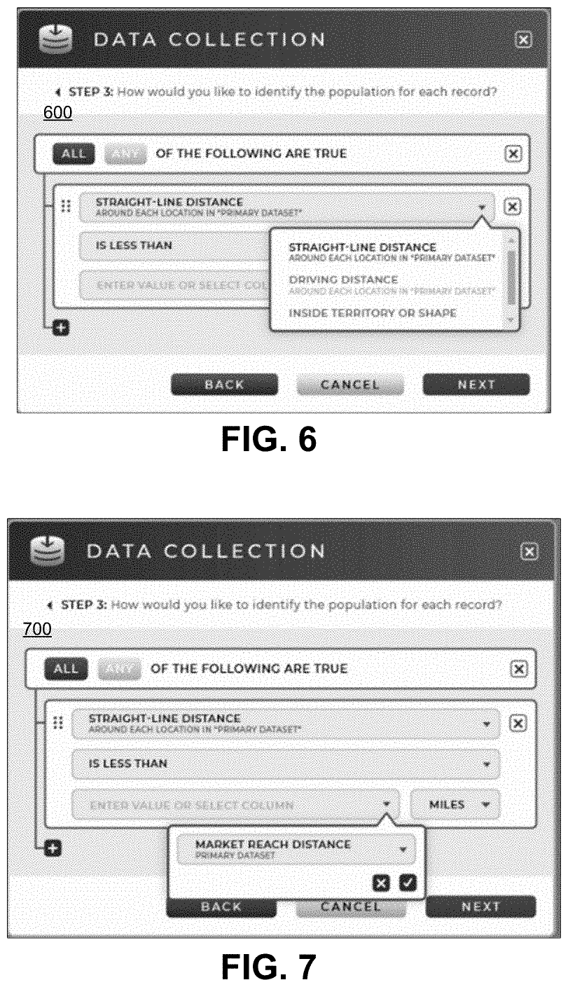

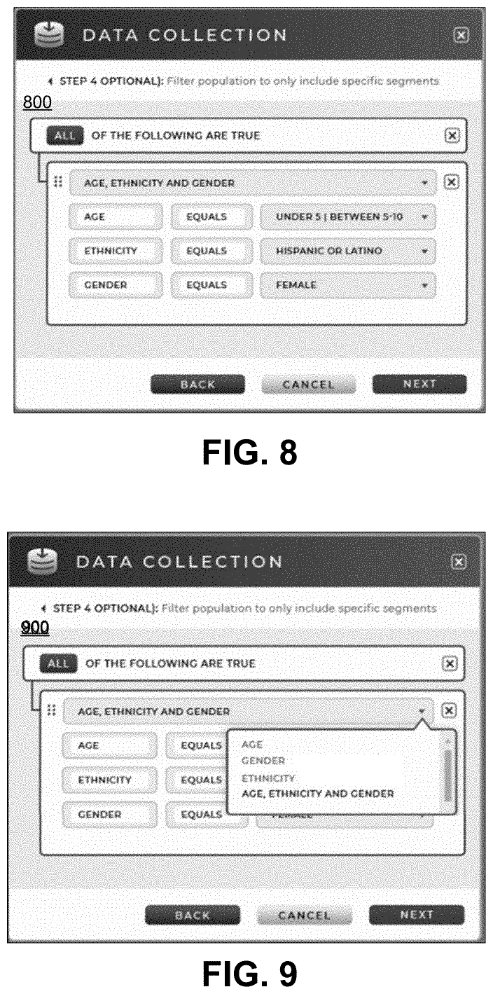

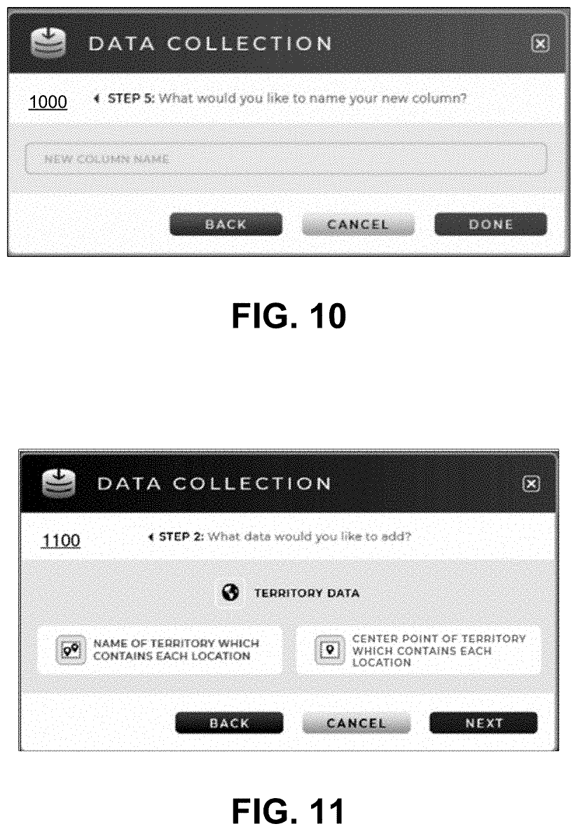

A first example scenario for data collection is depicted by FIGS. 4-10. In the example scenario, demographic information is collected based on a geospatial relation to each location in a primary dataset. FIG. 5 depicts a screenshot 500 corresponding to a scenario in which the user selects U.S. demographic data 404. After selecting U.S. demographic data 404, the use is shown categories of data 502-510 relating to U.S. demographic data. After a category of data is selected, the user may be shown the screenshot 600 shown in FIG. 6. At FIG. 6, a user selects filter parameters. As described above, geospatial filter logic can be applied to identify records from the secondary dataset that have a particular geospatial relationship to records of the primary dataset. In particular, screenshot 600 shows a user selecting a straight-line distance as the geospatial relationship. At FIG. 7, the screenshot 700 shows the selection of a logic operator and a value. In particular, the selected filter criteria for filtering records of the secondary dataset is a straight-line distance less than a market reach distance. Notably, the market reach distance is a column of the primary dataset. Consequently, for each record of the primary dataset, the secondary dataset will be filtered and reduced to records that are determined to be within the market reach distance value of the particular record of the primary dataset. Moving to FIG. 8, the user is provided with additional filter parameters. The filter parameters depicted in screenshot 800 apply to the demographic data itself. Because the “all” parameter is chosen, records from the secondary dataset will only be collected if they meet all the selected criteria. In alternative scenarios, a user may set the parameters so records will be collected if they meet any of the listed criteria. FIG. 9 further illustrates filter options for demographic data. FIG. 10 corresponds to the user completing the selection of filter parameters. Screenshot 1000 depicts a text entry field for the user to name the new column that is generated based on the selected secondary dataset source, geospatial relationship, and additional filter parameters as shown in the prior screens.

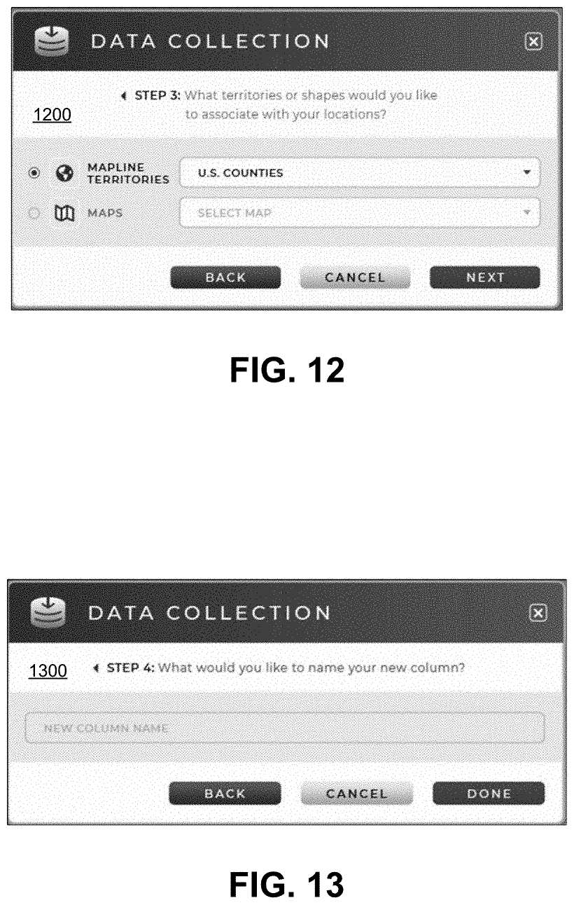

A second example scenario for data collection is depicted by FIGS. 11-13. FIG. 11 corresponds to the scenario in which a user selects “territory data” 416, as shown in FIG. 4. As shown in FIG. 11, the user has the option to select the type of data to add. Example options as shown in the figure include the name of the territory which contains each location, and the center point of the territory which contains each location. At FIG. 12, the user selects a territory set from a list of territory sets. Alternatively, the user can select a set of territories previously generated and saved on a map interface. In general, a territory set is a set of geospatial regions. A territory in example territory set may be defined by, e.g., a set of vertex coordinates (such as would be used to define a polygon), a center coordinate and a radius, a center coordinate and a base polygon, etc. In particular, the user selects the territory list “U.S. Counties.” In this data collection scenario, a geospatial relationship is identified for each record of the user's primary dataset by identifying the U.S. county in which the location resides. The result generated from this data collection scenario is an augmented primary dataset in which the territory (e.g. the territory name or the territory center point, based on the selection shown in FIG. 11) of each location is added to the record. FIG. 13 depicts a text entry field on the user interface for naming the new column.

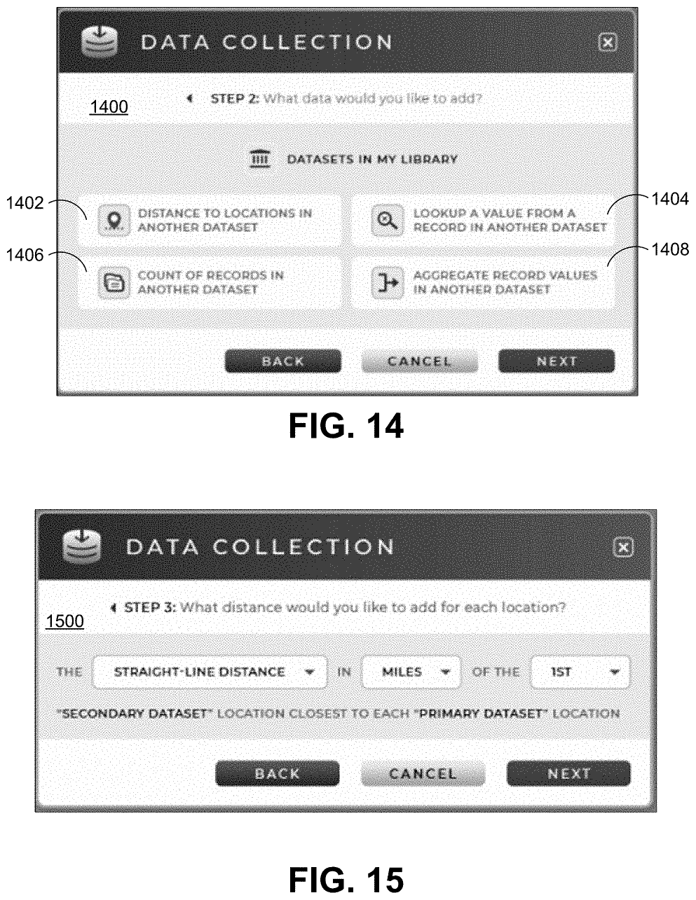

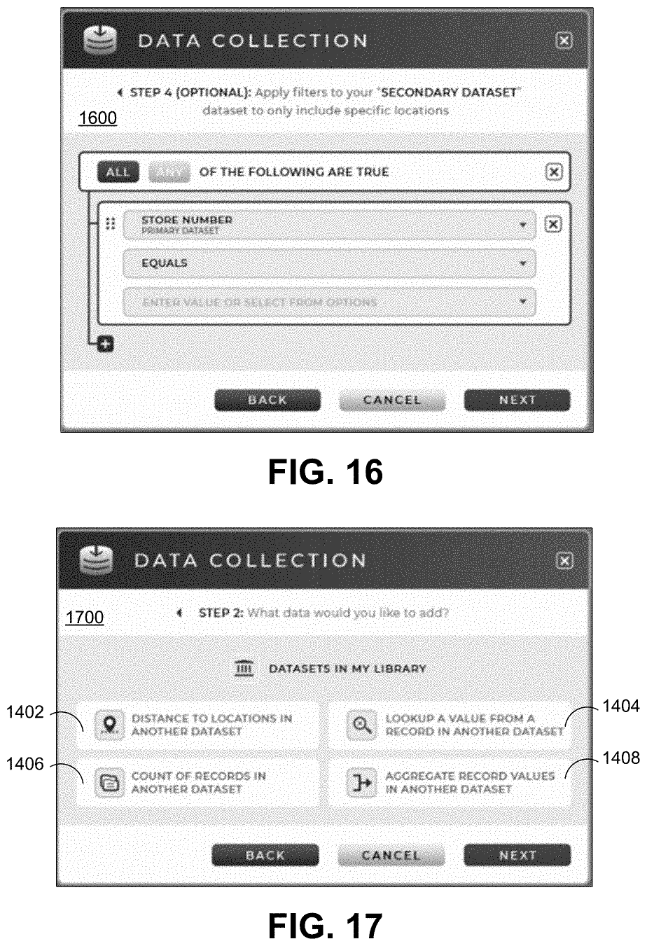

A third example scenario for data collection is depicted by FIGS. 14-16. In this scenario, a user collects data regarding distances between records of the primary dataset and records of a secondary dataset. In the scenario, a user has previously entered or imported a dataset comprising geospatial information. FIG. 14 is a screenshot corresponding to a scenario in which the user selects “datasets in my library” 402, as shown in FIG. 4. Upon choosing the option “distance to locations in another dataset” 1402, the user is presented with an option to choose the distance relationship and units, as shown in FIG. 15. In the example of FIG. 15, the relationship selected is a straight-line distance to the nearest location. Notably, FIG. 15 illustrates that an index field may be provided which allows the user to define which result to return. For example, as an alternative to the nearest location being used to generate the straight-line distance, an index of 2 may be chosen to instead utilize the 2^{nd}-nearest location. Generally, with index n selected, the n^{th}-nearest location is used. FIG. 16 shows a screenshot of an interface for entering optional additional filter criteria. With no additional criteria selected, the result generated from this data collection scenario is an augmented primary dataset in which the distance in miles to the nearest location of the secondary dataset is added to the record. Next, as is shown in previous examples, the user may be prompted to name the newly added column.

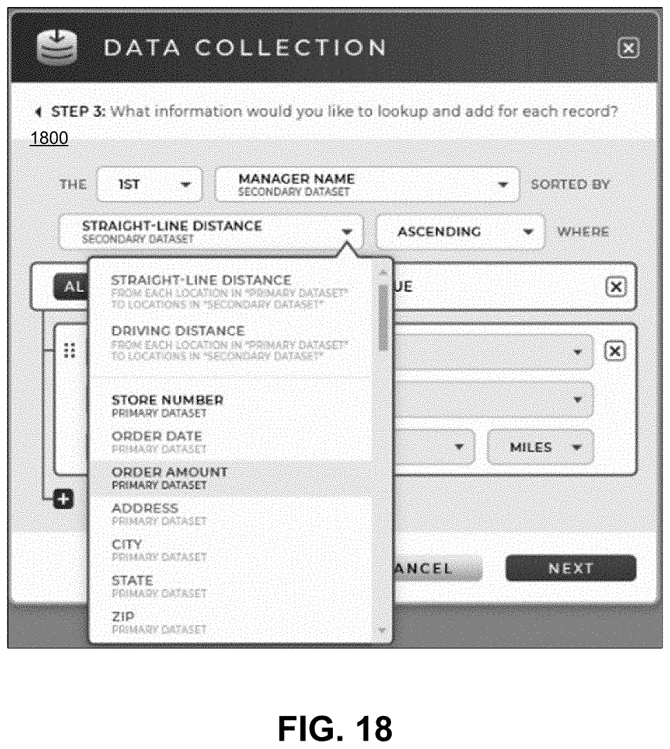

A fourth example scenario for data collection is depicted by FIGS. 17-18. In this scenario, collecting data includes a lookup of a value from a record of another dataset that is geospatially related to each record of the primary dataset. FIG. 17 is a screenshot corresponding to a scenario in which the user selects “datasets in my library” 402, as shown in FIG. 4. Upon choosing the option “lookup a value from a record in another dataset” 1404 as shown in FIG. 17, the user is prompted to set information to look up and add for each record of the primary dataset. FIG. 18 shows screenshot 1800 where the user is prompted to select a data type to sort by. In the example, the records are sorted ascending by straight-line distance. The user selects “manager name” as the data to be returned, and selects an index of 1. The result generated from this data collection scenario is an augmented primary dataset in which the manager name associated with the nearest location of the secondary dataset is added to each record.

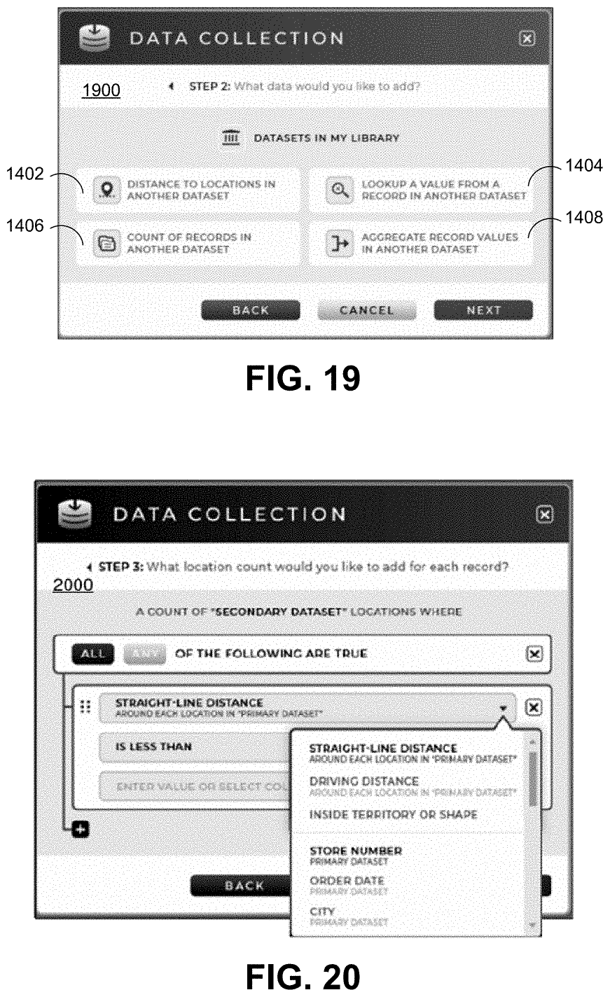

A fifth example scenario for data collection is depicted by FIGS. 19-20. In this scenario, collecting data includes counting the number of records in the secondary dataset matching the filter criteria for each record of the primary dataset. FIG. 19 is a screenshot corresponding to a scenario in which the user selects “datasets in my library” 402, as shown in FIG. 4. Upon choosing the option “count of records in another dataset” 1406 as shown in FIG. 19, the user is prompted to set geospatial relationship parameters as shown by FIG. 20. The geospatial relationship can also be combined with data relationships. For example, the user can configure multiple conditions, such as a straight-line distance of less than 5 miles, and where the store ID from the primary dataset is equivalent to the store ID from the secondary dataset. As shown in the figure, the user may select “any” or “all” to configure whether the conditions must all match or whether any of the provided conditions may match in order to return a result for each particular record. The result generated from this data collection scenario is an augmented primary dataset in which the number of records from the secondary dataset matching the specified criteria is added to each record.

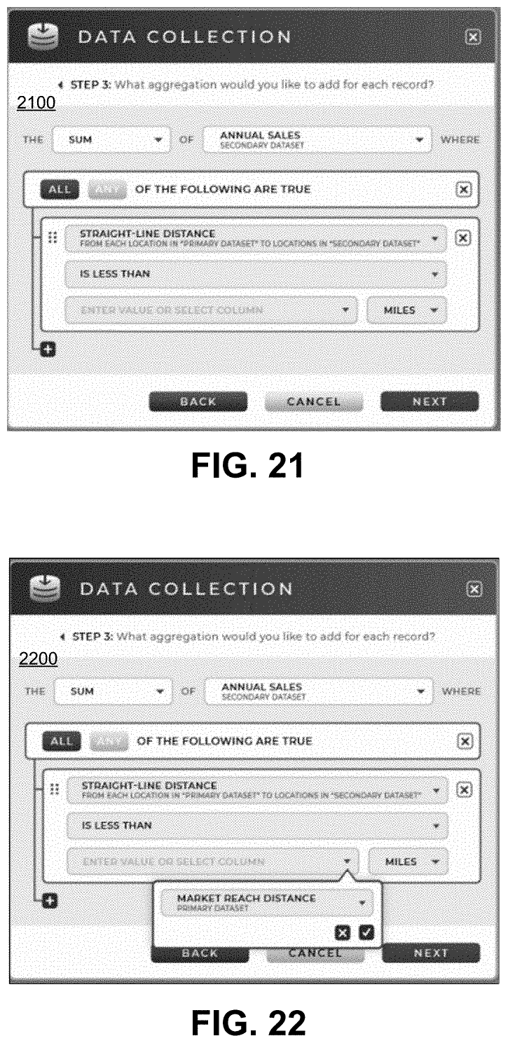

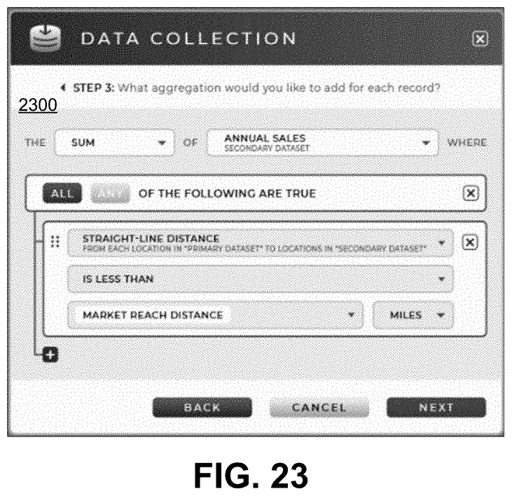

A sixth example scenario for data collection is depicted by FIGS. 21-23. IN this scenario, collecting data includes performing a calculation on aggregate data from a secondary dataset having locations that are geospatially related to each location of the primary dataset. In this scenario, a user selects “aggregate record values in another dataset” 1408. As shown in FIG. 21, the user is prompted to enter criteria for aggregating records. In the example scenario, the user chooses “sum” to apply to the data field “annual sales.” As depicted in FIGS. 22-23, geospatial relationship logic is selected and applied so that the summation of annual sales values is performed, for each record of the primary dataset, only on records of the secondary dataset having a straight-line distance less than the market reach distance defined by the particular record of the primary dataset. As discussed above, the geospatial relationships can be combined with data relationships as additional filter criteria.

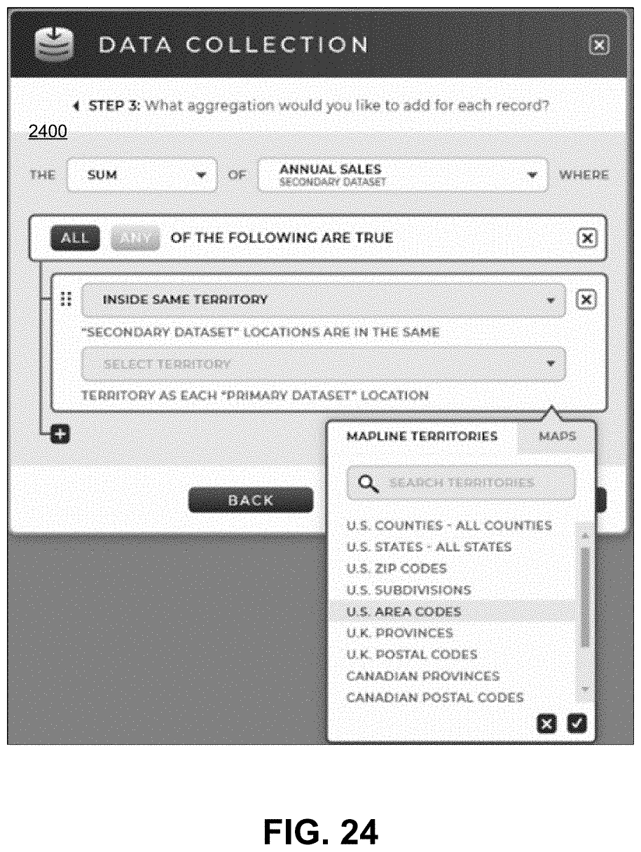

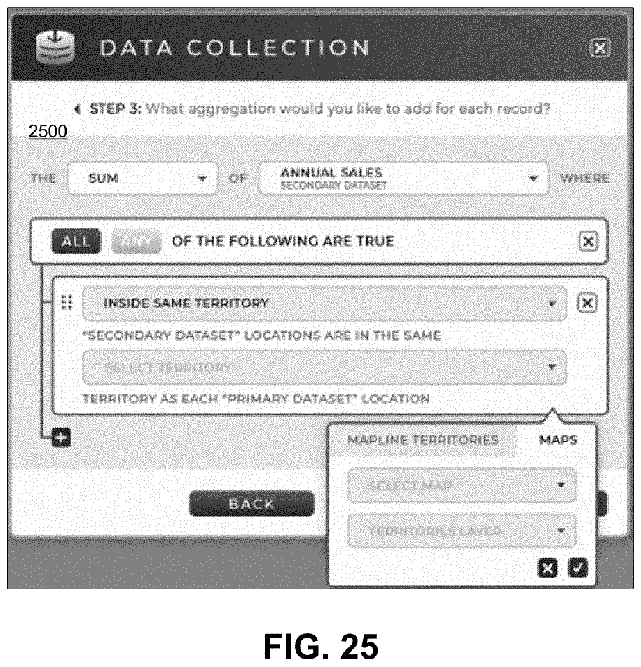

A variation on the sixth example scenario is depicted by FIGS. 24-25. In this scenario, the geospatial relationship logic is based on a determination that records of the primary and secondary dataset are inside the same territory. In this scenario, the user selects the territory set “U.S. Area Codes” from a list of territory set options.

After data has been collected onto a dataset to form an augmented dataset, the user can then use the augmented dataset in maps, filters, charts, reports, dashboards, surveys, and/or at a dataset/spreadsheet interface. In some embodiments, an augmented primary dataset is displayed at the same spreadsheet-like interface where the primary dataset is initially displayed and where the data collection process is initiated (e.g. the example interface depicted in FIG. 32). In such embodiments, a displayed primary dataset may be augmented by the addition of a new column that displays the collected data relevant to each record of the primary dataset.

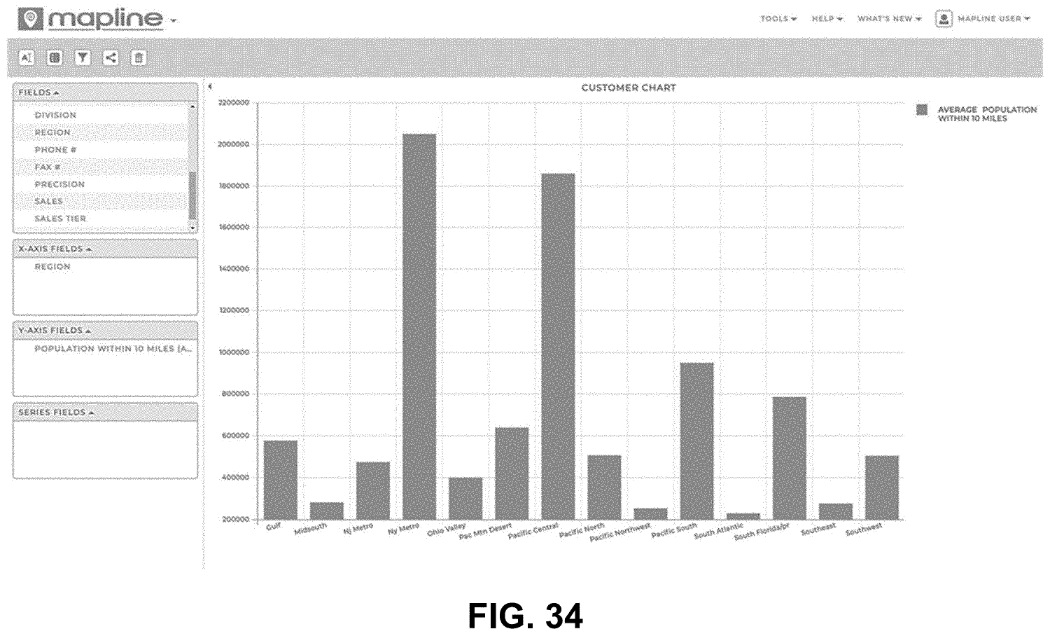

Some embodiments provide various ways to visualize and/or utilize data of an augmented dataset that is generated via data collection processes as described herein. FIGS. 34-43 provide example screenshots relating to utilizing and/or visualizing an augmented dataset. Such example screenshots could be presented as or via a client-side user interface of the present systems and methods. In some embodiments, an interface provides a display of data from an augmented dataset. In some embodiments, an interface provides features such as tools for customizing and generating the display of data from an augmented dataset.

In the examples below, an augmented dataset generated by data collection processes of the present systems and methods is utilized. The example augmented dataset may be generated as follows. A user first imports or enters a primary dataset comprising stores and corresponding locations. The primary dataset may comprise additional fields for each record, e.g. a “Region” field. The user titles the dataset “Customer Population” and the dataset is saved. Once the dataset has been saved, the user opens the dataset in the interface and clicks “Add Data” (as shown in FIG. 32) to begin the data collection process using a secondary dataset. Then the user is prompted to choose a data type (as shown in FIGS. 4-5) and chooses U.S. Demographic Data (404) and Population (502). The user sets relationship filter parameters (as shown in FIG. 6) by to specify a relationship of within a straight-line distance of 10 miles. The user names the new column where the population data will be added “Population within 10 Miles.” As a result, the augmented dataset titled “Customer Population” that contains a list of records where each record comprises a store, a corresponding location, and a corresponding data field yielding the population within 10 miles of the respective store. While an augmented dataset may be configured in a variety of ways using a wide variety of data types and parameters, the “Customer Population” augmented dataset described with respect to FIGS. 34-43 is provided merely as an illustrative example.

FIG. 34 depicts a chart that utilizes an augmented dataset, in accordance with some embodiments. A user may create a chart, by selecting fields from the augmented dataset. In the example of FIG. 34, a user generates a chart, by selecting the “Customer Population” dataset that is generated in the scenario described above. A “Region” field present in the dataset is selected (e.g. via drag-and-drop) for use as the X-axis of the chart. The “Population within 10 Miles” field is selected for the Y-axis. The resulting chart is a visualization of the average population within 10 miles of each store for stores split out by region. A chart generated in this scenario may dynamically be updated by selecting or swapping out different data fields from the augmented dataset. The chart may also be configured to automatically update based on changes to underlying data of the augmented dataset.

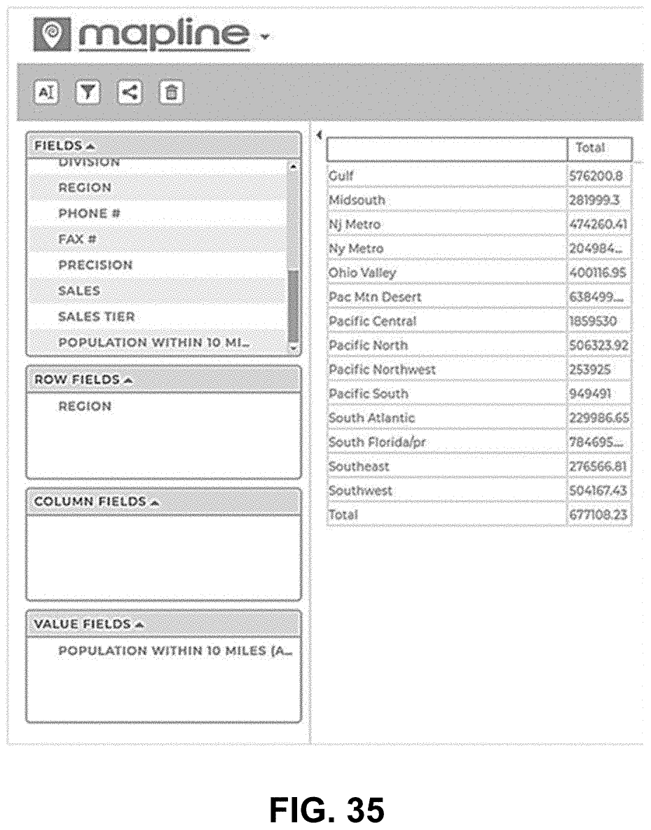

FIG. 35 depicts a report that utilizes an augmented dataset, in accordance with some embodiments. In the example, a report is generated from the “Customer Population” dataset described above. The user selects the dataset and selects fields from the dataset (e.g. via drag-and-drop) to appear as rows on a report table. Using the pre-existing “region” field for the rows of the report, and the “Population within 10 Miles” field as the column (or field values) of the report, the user generates a report showing the average population within 10 miles of each store, split out by region. The report may be configured to automatically update using processes described above.

In some embodiments, a map interface is provided. Map objects may be displayed on the map interface. Map objects may be configured to be associated with records of the primary dataset. Map object information may be displayed with map objects, for example by hovering over or selecting a map object to display its attributes. When additional data has been collected and a primary dataset has been augmented with new data, map object information may be augmented/updated based on the augmented dataset. For example, the map object may be augmented with the corresponding value associated with the additional data field of the augmented primary dataset.

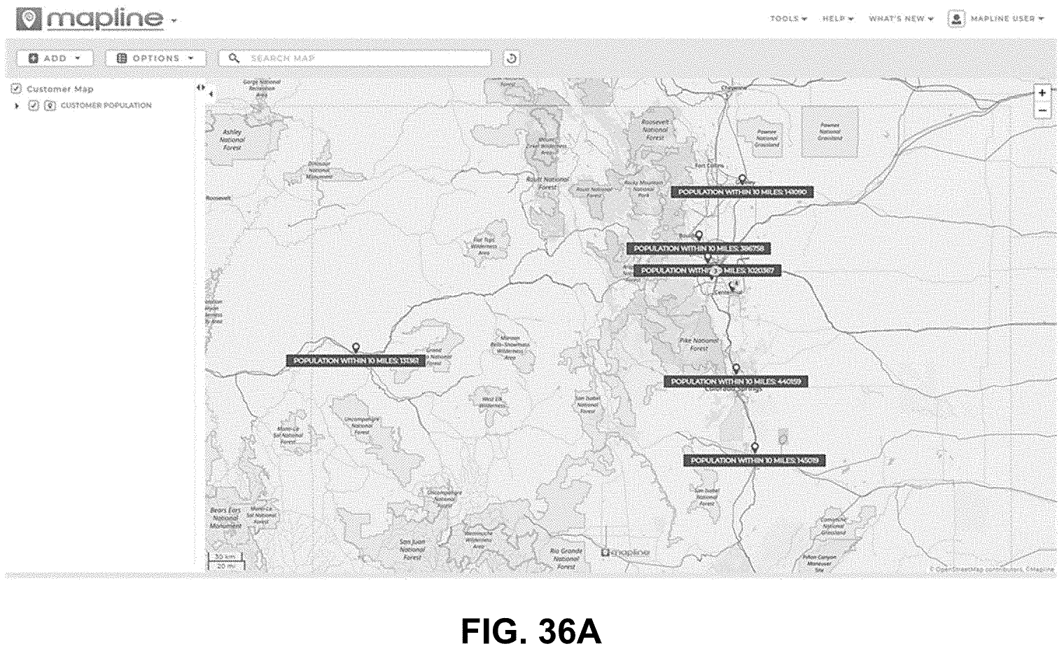

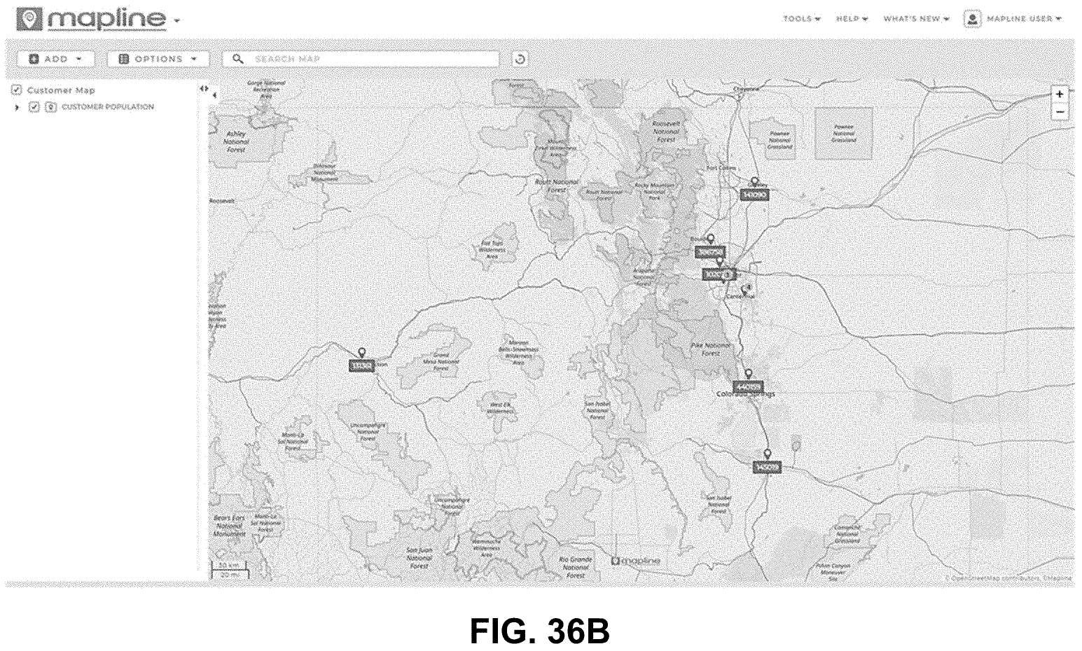

FIGS. 36A-36B depict a map interface that utilizes an augmented dataset, in accordance with some embodiments. In the example, a user creates a map titled “Customer Map” and selects the “Customer Population” described above. The dataset is then displayed on the map, e.g. by placing a pin or other map object for each record at its corresponding location. The user may configure a particular field from the dataset to appear as a label for each map object. In the example of FIG. 36A, the “Population within 10 Miles” field is selected, and the label for each location displays the field name and corresponding population value. In the example of FIG. 36B, the labels are configured to display only the corresponding population values.

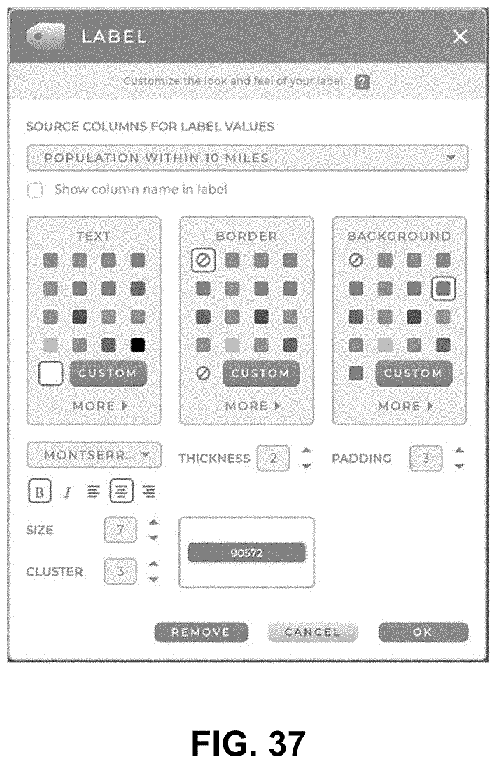

FIG. 37 depicts an interface element for customizing map labels, in accordance with some embodiments. As shown in the example, the source column for label values can be selected at the user interface, along with an option to show the name in the label. Text, border, and background color can be customized as well as font. Existing labels may be removed using the interface.

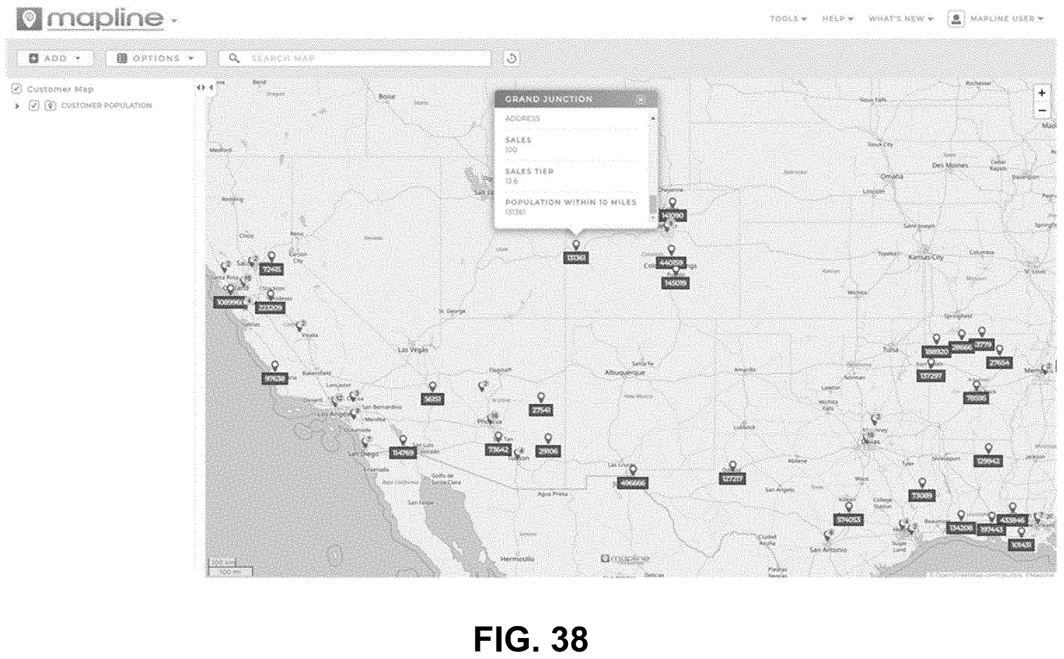

FIG. 38 depicts a map interface with pins and corresponding pop-out data views, in accordance with some embodiments. In accordance with some embodiments, a map object may be selected or hovered over in order to show each field and value of the dataset record that corresponds to the map particular map object. This “pop-out” view may be configured, for example, to display all fields or a subset of the data fields of the corresponding record.

A map interface may be utilized for further visualizations of geospatial data and representations of data from a user's dataset. For example, after calculating a new column on a user's dataset by collecting data from a secondary dataset source based on geospatial relationship between the two datasets, the new data may be visualized geospatially, e.g., as a heat map.

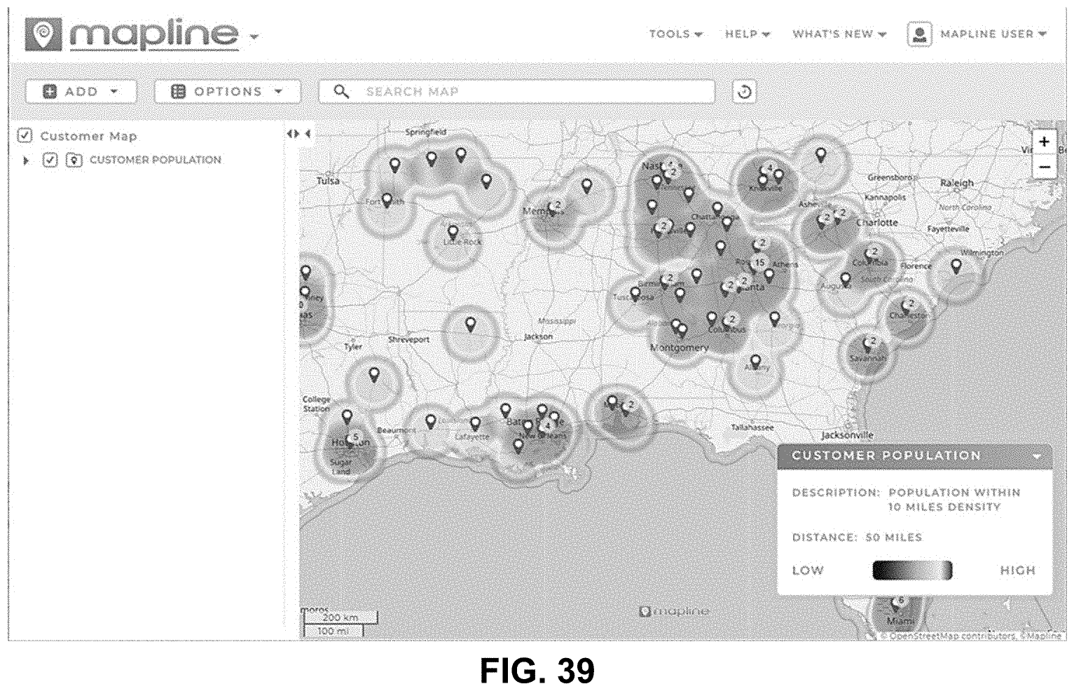

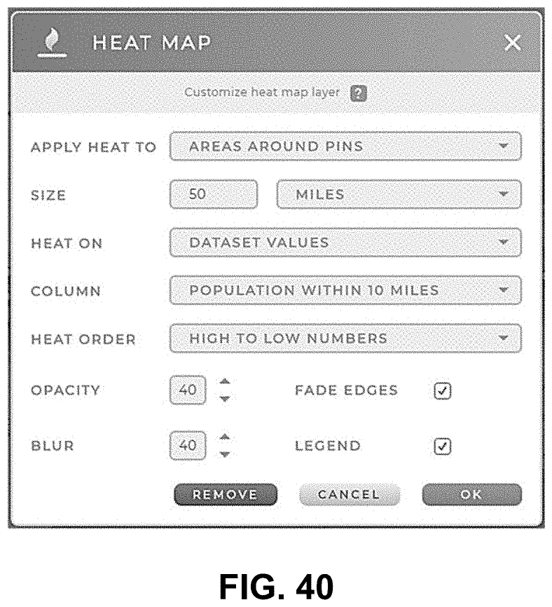

FIG. 39 depicts a heat map that utilizes an augmented dataset, in accordance with some embodiments. In the example, a user may generate a map and select the “Customer Population” dataset as described above. A user selects an option to generate a heat map onto the map. FIG. 40 depicts an interface element for customizing a heat map, in accordance with some embodiments. The heat map wizard prompts the user to select a data column for the heat map. In the example, the user selects the “Population within 10 miles” field from the augmented dataset. The heat map wizard may provide additional settings for customizing the visualization. The resulting heat map is shown in FIG. 39.

It may be especially useful to organize interactive map objects based on attribute data that is updated based on data collection methods described herein. A map object may correspond to a single record of a dataset and, for example, may appear as a point or shape displayed at a location corresponding to geospatial data of said record. In some embodiments, the user interface provides options for selecting criteria for segmenting map objects. For example, map objects meeting a user-specified criterion may be grouped together. Segmenting or grouping objects may include rendering map objects with the same pin style, pin color, or size based on a segmenting or grouping criteria. In some embodiments, a user can manually group map objects or directly set attribute values of map objects, which may ultimately be used as the basis for segmenting or grouping.

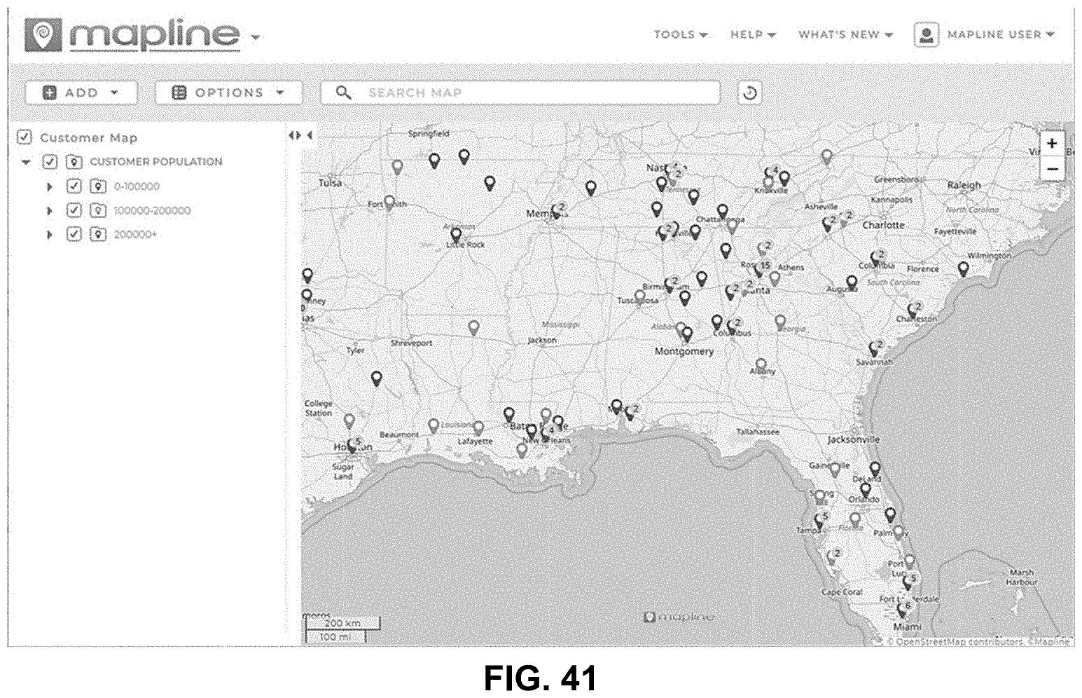

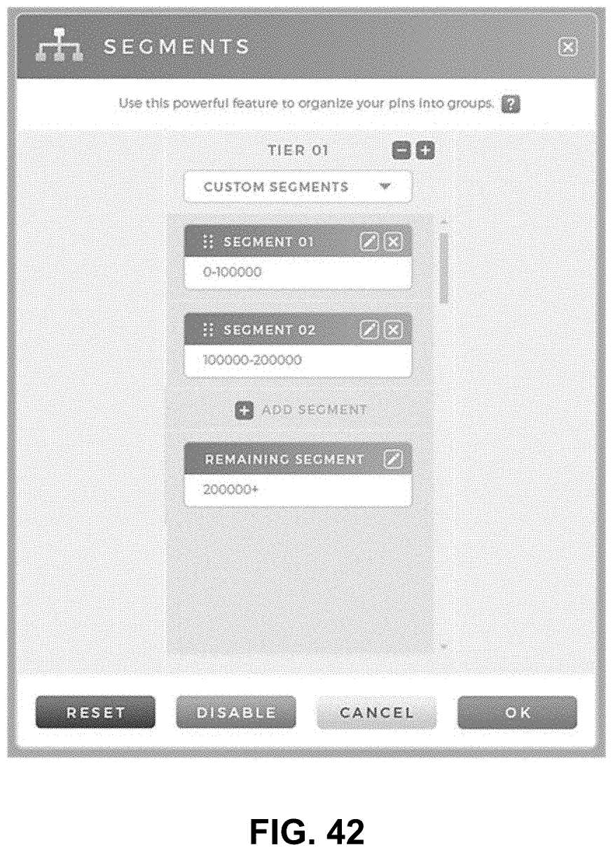

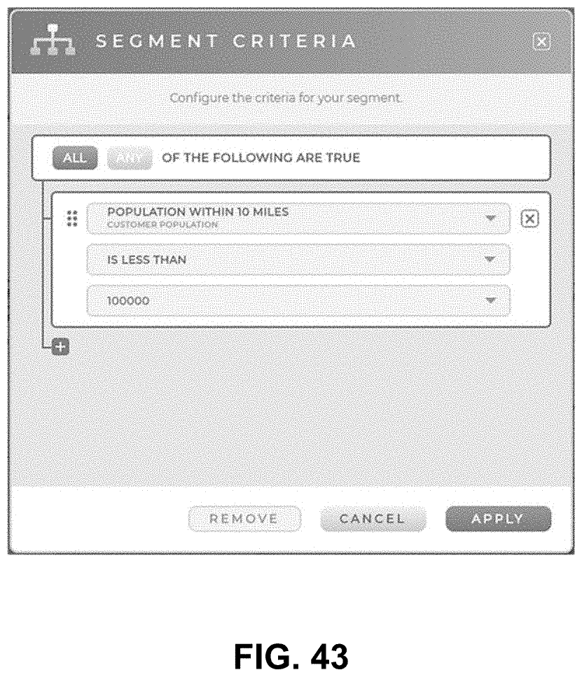

FIG. 41 depicts a map interface with segmented data, in accordance with some embodiments. In the example, a user creates a map and selects the “Customer Population” augmented dataset as described above. The user splits pins into groups (or “segments”) based on data from corresponding field values. Pins may be segmented, for example, by grouping by color. FIG. 42 depicts an interface element or wizard for segmenting data, in accordance with some embodiments. In the example, the user is first prompted to generate a number of segments, which can be labeled with a segment name. FIG. 43 depicts a second step of the wizard, where the user selects the criteria for a particular segment. In the example screenshot, the user sets the criteria for the first group. In the example, the user configures first segment to have the criteria set so that the “Population within 10 Miles” field value must be less than 100,000 to belong to the segment. Each segment may be configured in a similar manner. In some embodiments, a segment can be configured to contain the map objects that do not meet the criteria of any of the other specified segments.

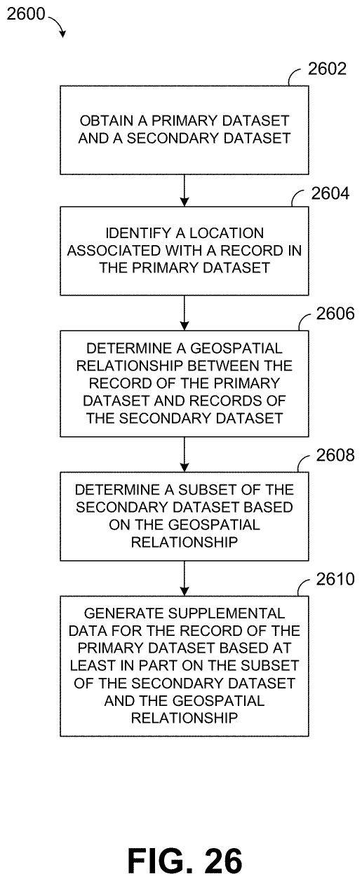

FIG. 26 is flow diagram of a first example method for collecting data based on identified geospatial relationships in accordance with some embodiments. The method 2600 includes, at 2602, obtaining a primary dataset and a secondary dataset. At 2604, the method further includes identifying a location associated with a record in the primary dataset. In some embodiments, the location is a coordinate or set of coordinates, e.g. latitude/longitude, X/Y coordinates, 3D Cartesian coordinates, and the like. At 2606, the method further includes determining a geospatial relationship between the record of the primary dataset and records of the secondary dataset. At 2608, the method further includes determining a subset of the secondary dataset based on the geospatial relationship. At 2610, the method further includes generating supplemental data for the record of the primary dataset based at least in part on the subset of the secondary dataset and the geospatial relationship.

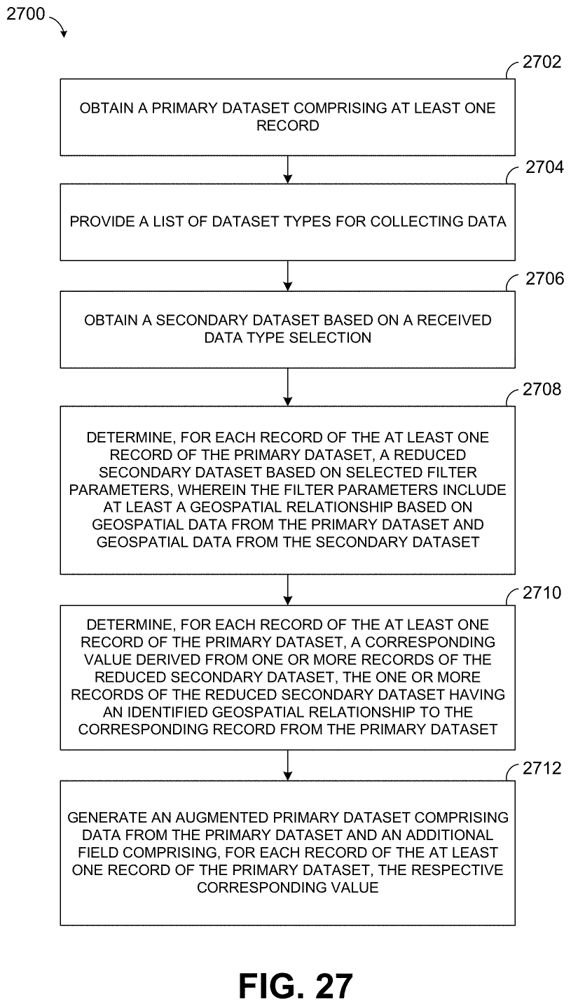

FIG. 27 is a flow diagram of a second example method for collecting data based on identified geospatial relationships in accordance with some embodiments. The method 2700 includes, at 2702, obtaining a primary dataset comprising at least one record. At 2704, the method includes providing a list of dataset types for collecting data. In some embodiments, providing a list of dataset types for collecting data includes providing a list of dataset sources. Providing a list of dataset types for collecting data may further include providing categories of data from which the user can choose based on a selected secondary dataset source. A data type selection can be retrieved based on the user's selection. At 2706, the method includes obtaining a secondary dataset based on a received data type selection. At 2708, the method includes determining, for each record of the at least one record of the primary dataset, a reduced secondary dataset based on selected filter parameters, wherein the filter parameters include at least a geospatial relationship based on geospatial data from the primary dataset and geospatial data from the secondary dataset. At 2710, the method further includes determining, for each record of the at least one record of the primary dataset, a corresponding value derived from one or more records of the reduced secondary dataset, the one or more records of the reduced secondary dataset having an identified geospatial relationship to the corresponding record from the primary dataset. At 2712, the method further includes generating an augmented primary dataset comprising data from the primary dataset and an additional field comprising, for each record of the at least one record of the primary dataset, the respective corresponding value.

In some embodiments, the filter parameters further include at least one data filter parameter that identifies (i) a data field of the secondary dataset and (ii) a filter condition, and wherein determining a reduced secondary dataset based on filter parameters includes filtering out records of the secondary dataset that do not meet the filter condition for the identified data field.

In some embodiments, the one or more records of the reduced secondary dataset comprise records of the secondary dataset that are determined to be within a range associated with the geospatial relationship to the corresponding record from the primary dataset.

In some embodiments, determining the corresponding value includes determining a total number of records in the reduced secondary dataset.

In some embodiments, determining, for each record of the at least one record of the primary dataset, the corresponding value includes sorting records of the reduced secondary dataset based on a provided sort column; and selecting a record from the reduced secondary dataset based on a received index number. In some such embodiments, the method includes retrieving the corresponding value from the selected record based on a selected data field from which to select the corresponding value. Alternatively, in some embodiments, the method includes retrieving the corresponding value by calculating a value representing a geospatial relationship between the at least one record of the primary dataset and the selected record from the reduced secondary dataset.

In some embodiments, determining, for each record of the at least one record of the primary dataset, the corresponding value includes: receiving a selected data field associated with the reduced secondary dataset; and determining the corresponding value based on a calculation using data values of the reduced secondary dataset corresponding to the selected data field.

In some embodiments, the geospatial relationship is a shared territory. In such embodiments, the method may further include selecting, at the user-interface, a territory set. In such embodiments, the one or more records of the reduced secondary dataset may include records of the secondary dataset that are determined to be within (or determined to not be within) a same territory as the corresponding record from the primary dataset. In some embodiments, a territory set is a user-created set of geospatial regions drawn on a map at the user interface.

In some embodiments, the example method 2700 further includes determining geospatial coordinates associated with records from the primary dataset based on the geospatial data from the primary dataset and determining geospatial coordinates associated with records from the secondary dataset based on geospatial data from the secondary dataset.

In further embodiments, an apparatus may be provided, comprising a computer-readable medium having instructions stored thereon that, when executed by a computer, cause the computer to perform any of the method steps described above.

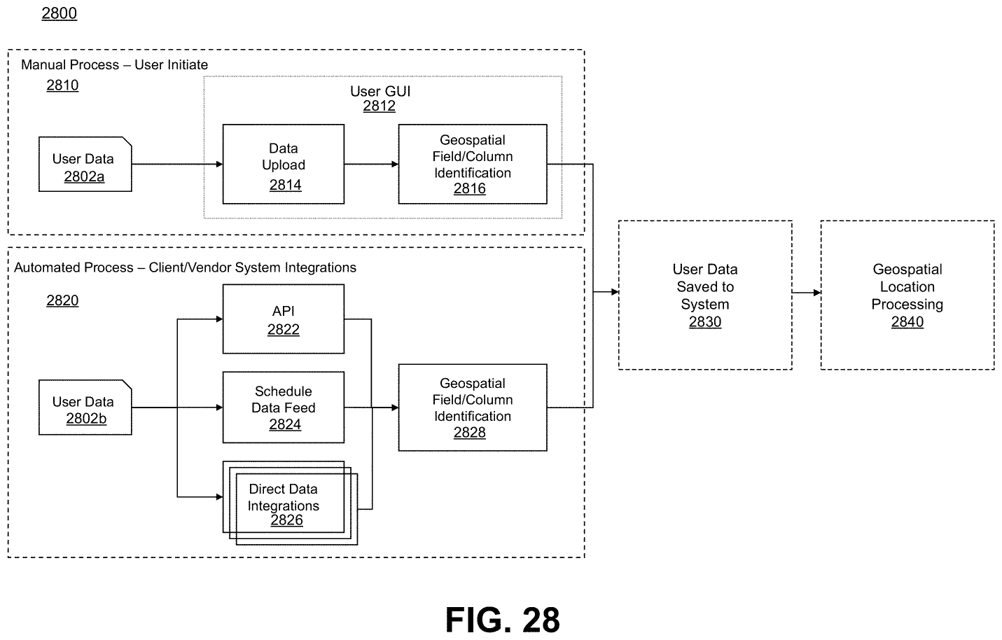

FIG. 28 is a block diagram depicting user data acquisition and preprocessing in accordance with some embodiments. Dataset data from a user can be imported in various ways. As shown in the example of FIG. 28, user data may be imported by a manual process 2810 or an automated process 2820. At 2810, user data 2802a is uploaded 2814 at user GUI 2812. In some embodiments, data can be uploaded from a spreadsheet application or from various other file types and integrations. Alternatively, a user can manually create data via data entry into the GUI, or by e.g. opening a file, selecting data, copying and pasting data into the GUI. Datasets may be added, edited, and/or replaced in the manner discussed above.

At 2816, the fields and/or columns containing geospatial data are identified. In some embodiments, if uploaded manually at user GUI 2812, the user can be prompted to manually identify what fields are associated with location information such as coordinates, and address details. In some embodiments, a user can drop pins on a map manually as a set of locations to create a dataset.

Alternatively and/or in addition to manual process 2810, at 2820, user data 2802b can be uploaded using one or more automated processes. At 2822, an API is utilized to programmatically create data. At 2824, a schedule data feed (e.g. an XML feed) is established based on a user's requests to send data to the system via FTP or SFTP. The data can be embedded into an XML or JSON file which identifies the dataset. At 2826, user data is imported using one of various pre-developed integrations with various vendor software for pulling and pushing data to and from the vendor system into the data collection and aggregation system.

At block 2830, user data (e.g. from manual process 2810 and/or automated process 2820) is saved to the system. At 2840, records that have been imported are processed for geospatial information.

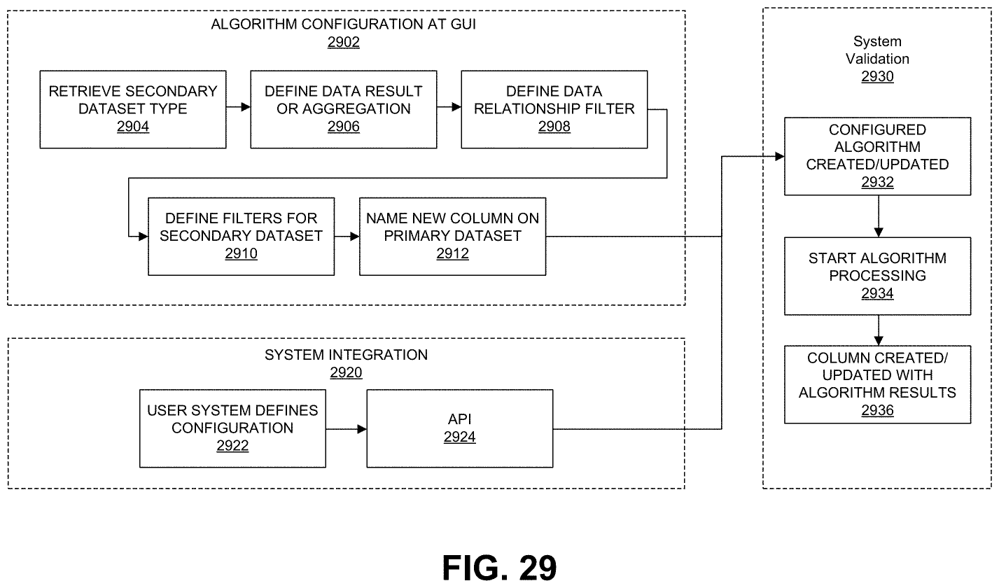

FIG. 29 is a block diagram depicting a data collection process in accordance with some embodiments. In accordance with some embodiments, a user can add additional information to an existing dataset from other secondary dataset sources by making use of the data collection algorithm as described herein. At block 2902, the data collection algorithm is configured at the GUI. At 2904, a dataset type is retrieved. A dataset type may be retrieved, for example, as follows. First, a dataset source (e.g. a source from which the user would like to gather data) is selected by the user at the GUI. Next, based on the secondary dataset source selected, certain categories of data from which the user can choose are provided at the GUI. Finally, the dataset type is retrieved via the user selection of the particular category. At 2906, data can be refined or aggregated when adding it to the primary dataset. For example, data can be aggregated by applying standard calculations such as but not limited to count, sum, average, median, standard deviation, maximum, minimum, largest, smallest, mid-point, and center point of minimum distance. Data can also be sorted based on another data field in the secondary data, ascending or descending based on user preferences. For example, the user can then choose to get the 1st, 2nd, 3rd, . . . nth result from the secondary dataset records.

At 2908, the relationship filter between their primary dataset and the secondary dataset is defined, e.g. by the user. This can be done, for example, by mapping columns on the primary dataset to fields in the secondary dataset and utilizing the standard operators including but not limited to equals, less than, less than or equal, is one of a list, is not of a list, starts with, does not start with, ends with, and does not end with, contains, and does not contain. Alternatively, the relationship filter can be defined by a geospatial relationship of the user's primary dataset geospatial fields, usually but not always a coordinate, relative to the secondary dataset's geospatial fields. The geospatial relationship filter can be of many different types including but not limited to a straight-line distance, driving distance using shortest route, driving time based on shortest route, driving time based on current traffic conditions, or a map shape that the secondary dataset and user's primary dataset record both lie within. The shared map shape can be selected by the user and can be either one defined by the user or from a list of predefined well-known or governmental shapes. For other types of geospatial relationship filters, the user can provide a static value and units that the static value represents. In order to be related to the user's primary dataset record, the secondary dataset data point must be less than or equal to the user provided static value. Thus, in embodiments where a reduced secondary dataset is obtained, the reduced secondary dataset can be obtained based on such a geospatial relationship filter. That is, at least some of the relationship filters selected at the user interface include geospatial relationships based on geospatial data.

The user can also specify more than one criterion of either type when defining the relationship filter. Criteria can be linked hierarchically. Criteria with the same parent are logically evaluated together using the operators “All”, meaning all criteria with the same parent must be true, or “Any” meaning one or more criterion with the same parent must be true.

At 2910, after defining the relationship filter criteria, the user can choose to filter the secondary dataset before merging with the primary dataset. In this case, the criteria defined for filtering only pertains to the secondary dataset records. The user can filter by defining static values or comparing fields on the secondary dataset. Similar to the relationship filter criteria, the user can choose between standard logical operators including but not limited to equals, less than, less than or equal, is one of a list, is not of a list, starts with, does not start with, ends with, and does not end with, contains, does not contain, is blank, and is not empty.

At 2912, the last step in the data collection algorithm configuration is to name the column of data that is being added to the user's dataset.

Alternatively, at 2920 data collection algorithm configuration may be performed via a system integration. At 2922 a user system defines the configuration, and at 2924 an API communicates the configuration to system validation 2930. At 2932, the configured algorithm is created or updated. At 2934, the algorithm (e.g. the process/calculation for generating resultant data for augmenting the primary dataset) begins. At 2936, a column is created or updated with the results of the algorithm.

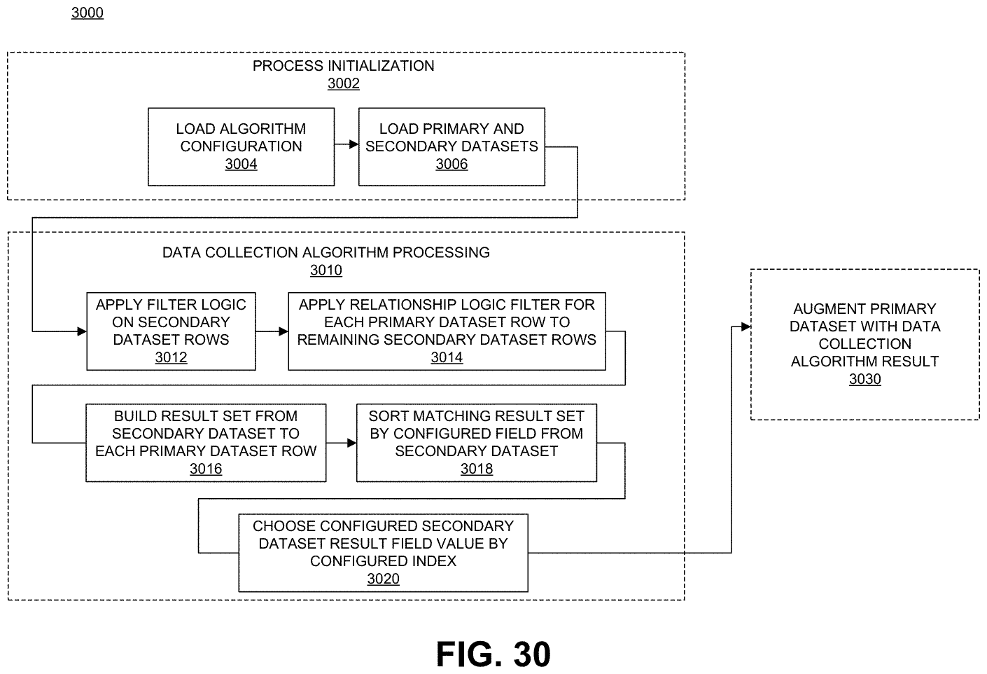

FIG. 30 is a block diagram depicting a data collection process for a lookup calculation, in accordance with some embodiments. In process initialization 3002, the algorithm configuration is loaded at 3004. At 3006, primary and secondary datasets are loaded.

As shown in the example of FIG. 30, data collection algorithm processing for a lookup calculation begins with applying the filter logic on the secondary dataset at 3012. At 3014, relationship filter logic for each primary dataset row is applied to each secondary dataset row. At 3016, a result set is built from secondary dataset data to each primary dataset row. At 3018, a matching result set is sorted by a selected/configured secondary dataset field. At 3020, a secondary dataset result field value is chosen based on a selected/configured index value. At 3030, the primary dataset is augmented with the data collection algorithm result. In some embodiments, the data is augmented with the result field on which the secondary dataset is sorted (e.g. by returning the value of the result field having the selected index). In some embodiments, the data is augmented with a calculated distance from the record of the secondary dataset which has been chosen based on the selected/configured index value.

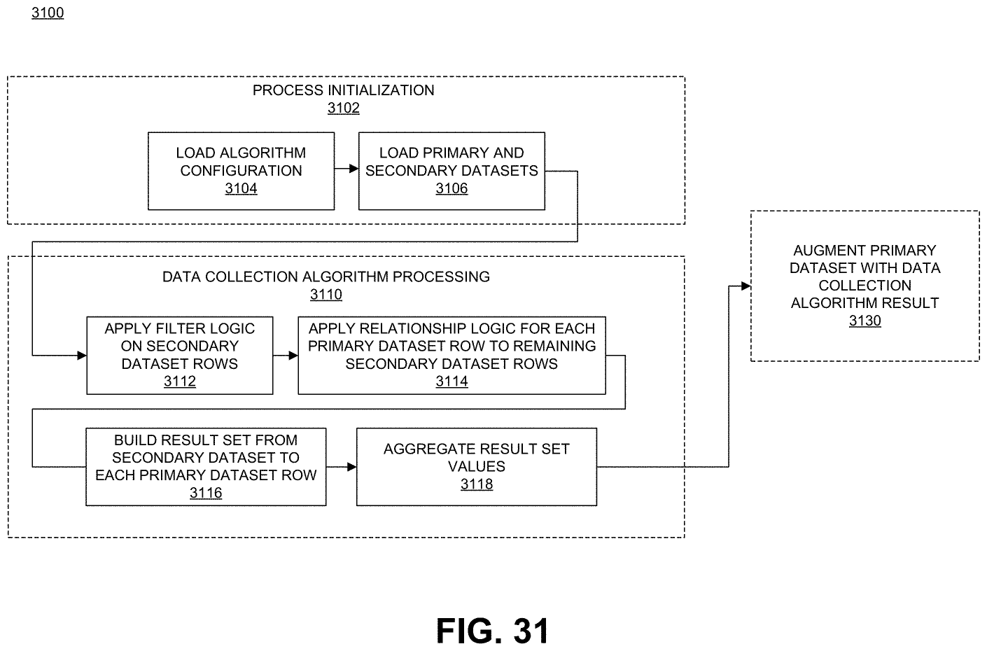

FIG. 31 is a block diagram depicting a data collection process for an aggregation calculation, in accordance with some embodiments. The data collection process for an aggregation calculation occurs in substantially the same manner as the data collection algorithm for the lookup calculation. However, instead of sorting matching results by configured secondary dataset field and choosing a configured secondary dataset result field value based on a selected/configured index value, the process includes aggregating result set values at 3120, e.g. by performing a calculation such as count, sum, average, standard deviation, and the like on the resultant values.

As the algorithm is executed, a result set is built from the secondary dataset against each row in the primary dataset. First, the algorithm's secondary dataset filter criteria are applied to the secondary dataset records and then the relationship filter criteria to merge the records. If a geospatial calculation is used in the aggregation or result, in a relationship criterion, in a filter criterion, or to sort the resulting secondary dataset records, the geospatial calculation is performed for the primary dataset location to each record in the secondary dataset and is added as a column in the primary dataset.

After each primary dataset row has the result set built from the secondary dataset, the aggregation is calculated, or the records are sorted and indexed for individual result selection based on the configuration of the data collection algorithm. The result is assigned to the new column on the primary dataset based on the result of the aggregation or individual record indexing.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Such a storage medium may be provided by a third-party provider such as a cloud storage/server system including Amazon Web Services, and the like. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method comprising:
obtaining a primary dataset comprising at least one record;
providing, at a user interface, a list of dataset types for collecting data;
obtaining a secondary dataset based on a received dataset type selection;
determining, for each record of the at least one record of the primary dataset:
a reduced secondary dataset based on filter parameters selected at the user interface, wherein the filter parameters include at least a geospatial relationship based on geospatial data from the primary dataset and geospatial data from the secondary dataset; and
a corresponding value derived from one or more records of the reduced secondary dataset, the one or more records of the reduced secondary dataset having an identified geospatial relationship to the corresponding record from the primary dataset; and
generating an augmented primary dataset comprising:
data from the primary dataset; and
an additional data field comprising, for each record of at the least one record of the primary dataset, the respective corresponding value.

2. The method of claim 1, wherein the secondary dataset comprises at least one of demographic data, weather data, crime data, traffic data, territory data, company locations, points of interest, and business data.

3. The method of claim 1, further comprising automatically updating the augmented primary dataset in response to a modification to at least one of the primary dataset and the secondary dataset.

4. The method of claim 1, wherein the geospatial relationship is selected from the group consisting of a straight-line distance, a shared territory, a driving distance, and a driving time associated with a route.

5. The method of claim 1, wherein the filter parameters further include at least one data filter parameter that identifies (i) a data field of the secondary dataset and (ii) a filter condition, and wherein determining a reduced secondary dataset based on filter parameters comprises filtering out records of the secondary dataset that do not meet the filter condition for the identified data field.

6. The method of claim 1, wherein determining, for each record of the at least one record of the primary dataset, the corresponding value comprises:
determining a total number of records in the reduced secondary dataset.

7. The method of claim 1, wherein determining, for each record of the at least one record of the primary dataset, the corresponding value comprises:
sorting records of the reduced secondary dataset based on a provided sort column; and
selecting a record from the reduced secondary dataset based on a received index number.

8. The method of claim 7, further comprising retrieving the corresponding value from the selected record based on a selected data field from which to select the corresponding value.

9. The method of claim 7, further comprising determining the corresponding value by calculating a value representing a geospatial relationship between the at least one record of the primary dataset and the selected record from the reduced secondary dataset.

10. The method of claim 1, wherein determining, for each record of the at least one record of the primary dataset, the corresponding value comprises:
receiving a selected data field associated with the reduced secondary dataset; and
determining the corresponding value based on a calculation using data values of the reduced secondary dataset corresponding to the selected data field.

11. The method of claim 1, wherein the one or more records of the reduced secondary dataset comprise records of the secondary dataset that are determined to be within a range associated with the geospatial relationship to the corresponding record from the primary dataset.

12. The method of claim 1, wherein the geospatial relationship is a shared territory, the method further comprising:
selecting, at the user-interface, a territory set.

13. The method of claim 12, wherein the one or more records of the reduced secondary dataset comprise records of the secondary dataset that are determined to be within a same territory as the corresponding record from the primary dataset.

14. The method of claim 12, wherein the territory set is a user-created set of geospatial regions drawn on a map at the user interface.

15. The method of claim 12, wherein the corresponding value identifies the respective territory.

16. The method of claim 1, further comprising:
determining geospatial coordinates associated with records from the primary dataset based on the geospatial data from the primary dataset; and
determining geospatial coordinates associated with records from the secondary dataset based on geospatial data from the secondary dataset.

17. The method of claim 1, further comprising:
generating a data visualization based on the augmented dataset; and
displaying the data visualization at the user interface.

18. The method of claim 1, further comprising:
displaying, on a map displayed at the user interface, map objects associated with records from the primary dataset; and
displaying map object information for corresponding map objects, the map object information for a particular map object corresponding to its associated record from the primary dataset; and
updating the map object information with the additional data field of the augmented primary dataset.

19. A computer-readable medium having instructions stored thereon that, when executed by a computer, cause the computer to:
obtain a primary dataset comprising at least one record;
provide, at a user interface, a list of dataset types for collecting data;
obtain a secondary dataset based on a received dataset type selection;
determine, for each record of the at least one record of the primary dataset:
a reduced secondary dataset based on filter parameters selected at the user interface, wherein the filter parameters include at least a geospatial relationship based on geospatial data from the primary dataset and geospatial data from the secondary dataset; and
a corresponding value derived from one or more records of the reduced secondary dataset, the one or more records of the reduced secondary dataset having an identified geospatial relationship to the corresponding record from the primary dataset; and
generate an augmented primary dataset comprising:
data from the primary dataset; and
an additional data field comprising, for each record of at the least one record of the primary dataset, the respective corresponding value.

20. A method comprising:
obtaining a primary dataset and a secondary dataset;
identifying a location associated with a record in the primary dataset;
determining a geospatial relationship between the record of the primary dataset and records of the secondary dataset;
determining a subset of the secondary dataset based on the geospatial relationship; and
generating supplemental data for the record of the primary dataset based at least in part on the subset of the secondary dataset and the geospatial relationship.
